(19) United States
(12) Patent Application Publication
(10) Pub. No.: US 2026/0086418 A1
(43) Pub. Date: Mar. 26, 2026

(54) SYSTEMS, DEVICES, AND METHODS UTILIZING HYBRID PHOTONIC CRYSTAL CAVITIES

(71) Applicants: The MITRE Corporation, McLean, VA (US); Massachusetts Institute of Technology, Cambridge, MA (US)

(72) Inventors: Mark DONG, Somerville, MA (US); Andrew GREENSPON, McLean, VA (US); Dirk ENGLUND, Brookline, MA (US)

(73) Assignees: The MITRE Corporation, McLean, VA (US); Massachusetts Institute of Technology, Cambridge, MA (US)

(21) Appl. No.: 19/339,190

(22) Filed: Sep. 24, 2025

Related U.S. Application Data
(60) Provisional application No. 63/698,376, filed on Sep. 24, 2024.

(51) Int. Cl. G02F 1/295

(52) U.S. Cl. CPC G02F 1/2955

(57) ABSTRACT

An apparatus comprising at least one photonic crystal cavity includes a grating comprising a first dielectric material and a nanobeam comprising a second dielectric material deposited on a surface of the grating, wherein a longitudinal axis of the nanobeam is oriented at a non-parallel angle to the grating. A photonic system comprises a photonic crystal cavity comprising a dielectric grating and a dielectric nanobeam deposited on a surface of the grating. A longitudinal axis of the nanobeam is oriented in a non-parallel arrangement to the grating, and a first distal region of the photonic crystal cavity is affixed to a substrate. A piezoelectric component comprises a free-floating distal region connected to a second distal region of the photonic crystal cavity. A voltage source is configured to apply a voltage to the piezoelectric component, generating strain in the photonic crystal cavity.

### CROSS-REFERENCE TO RELATED APPLICATIONS

This application claims the benefit of U.S. Provisional Application No. 63/698,376, filed Sep. 24, 2024, the entire contents of which is incorporated herein by reference.

### FIELD

The present disclosure relates generally to photonic crystal cavities.

### BACKGROUND

Photonic crystal (PhC) cavities are widely utilized in optics for applications including spectroscopy, filtering, sensing, laser oscillators, nonlinear optics, and quantum computing. In quantum computing, PhC cavities are often critical for improving optical coupling to quantum computing systems that utilize color centers in diamond or quantum dots or molecules in various materials as quantum emitters. PhC cavities have also been used to demonstrate compact PhC modulators by enabling the amplification and control of small shifts in refractive index. However, the fabrication of nanoscale features required to define PhC cavities remains difficult, particularly in materials that lack mature fabrication processes and for applications for which short optical wavelengths are required.

### SUMMARY

Described herein are systems, devices, and methods utilizing photonic crystal (PhC) cavities formed by placing a nanobeam of a first dielectric material onto a grating of a second dielectric material. These “hybrid” PhC cavities may be formed using reliable, standardized processing techniques (for example, CMOS manufacturing processes) with widely-utilized semiconductor materials that can be fabricated into complex, subtly-varied geometries with relative ease. This ease of fabrication can facilitate straightforward integration of the disclosed hybrid PhC cavities in photonic systems and devices such as photonic integrated circuit platforms for quantum computing.

In some embodiments, an apparatus comprising at least one photonic crystal cavity is provided, the at least one photonic crystal cavity comprising: a grating comprising a first dielectric material; and a nanobeam comprising a second dielectric material deposited on a surface of the grating, wherein a longitudinal axis of the nanobeam is oriented at a non-parallel angle to the grating.

In some embodiments, a pitch of the grating varies along a direction parallel to the longitudinal axis of the nanobeam.

In some embodiments, the pitch of the grating increases from a medial region of the grating to distal regions of the grating.

In some embodiments, the pitch of the grating decreases from a medial region of the grating to a distal regions of the grating.

In some embodiments, the pitch of the grating varies adiabatically.

In some embodiments, an adiabatic taper length of the grating is between 0 um and 20 um.

In some embodiments, between a midpoint of the grating and an edge of the grating, the grating comprises between 5 and 30 periods.

In some embodiments, a thickness of the grating is between 100 and 200 nm.

In some embodiments, a duty cycle of the grating is between 25% and 75%.

In some embodiments, the duty cycle of the grating is about 50%.

In some embodiments, a pitch of the grating along a direction parallel to the longitudinal axis of the nanobeam is constant.

In some embodiments, the pitch of the grating is between 150 nm and 250 nm.

In some embodiments, a width of the nanobeam varies along the longitudinal axis of the nanobeam.

In some embodiments, the width of the nanobeam increases from a medial region of the nanobeam to distal regions of the nanobeam.

In some embodiments, the width of the nanobeam decreases from a medial region of the nanobeam to distal regions of the nanobeam.

In some embodiments, the width of the nanobeam at a midpoint of the longitudinal axis of the nanobeam is between 150 nm and 500 nm.

In some embodiments, the width of the nanobeam tapers by between 0 μm and 400 nm between a midpoint of the longitudinal axis of the nanobeam and an interior edge of a distal region of the grating.

In some embodiments, a thickness of the nanobeam is between 50 nm and 200 nm.

In some embodiments, the nanobeam is a waveguide.

In some embodiments, the nanobeam comprises one or more quantum emitters.

In some embodiments, an emitter mode of the one or more quantum emitters is spectrally aligned with a cavity mode of the photonic crystal cavity.

In some embodiments, the second dielectric material is diamond.

In some embodiments, the first dielectric material is silicon nitride (SiN).

In some embodiments, the grating is deposited on a surface of a substrate.

In some embodiments, the substrate comprises silicon dioxide (SiO₂).

In some embodiments, a mode volume of the photonic crystal cavity is less than 1.5 (λ/η_{eff})³, where η_{eff} is an effective refractive index of a cavity mode.

In some embodiments, a quality factor of the photonic crystal cavity is greater than 10⁵.

In some embodiments, the photonic crystal cavity was fabricated using a semiconductor manufacturing process.

In some embodiments, the photonic crystal cavity was fabricated using CMOS fabrication techniques.

In some embodiments, a photonic system is provided, comprising: a photonic crystal cavity comprising: a grating comprising a first dielectric material; and a nanobeam comprising a second dielectric material deposited on a surface of the grating, wherein a longitudinal axis of the nanobeam is oriented perpendicular to the grating; and an output waveguide, wherein a distal region of the output waveguide underlies and is optically coupled to receive light from a distal region of the nanobeam.

In some embodiments, a photonic system is provided, comprising: a photonic crystal cavity comprising: a grating comprising a first dielectric material; and a nanobeam comprising a second dielectric material deposited on a surface of the grating, wherein a longitudinal axis of the nanobeam is oriented perpendicular to the grating; wherein a pitch of adjacent dielectric beams the grating within an adiabatic taper region varies adiabatically and widths of individual dielectric beams of the grating are alternated in the adiabatic taper region of the grating, wherein the adiabatic pitch variation and beam width alternation cause light from the cavity to be emitted upward from the cavity. In some embodiments, the photonic system further comprises: a substrate, wherein the grating is deposited on a surface of the substrate; and a metal backplane for the substrate, wherein the backplane is configured to redirect light emitted by the nanobeam into the substrate away from the substrate. In some embodiments, the photonic system further comprises: a substrate, wherein the grating is deposited on a surface of the substrate; and a metal backplane for the substrate, wherein the backplane is configured to redirect light emitted by the cavity that would originally transmit into the substrate such that the light instead emits upward away from the substrate.

In some embodiments, a photonic system is provided, comprising: a photonic crystal cavity comprising: a grating comprising a first dielectric material; and a nanobeam comprising a second dielectric material deposited on a surface of the grating, wherein a longitudinal axis of the nanobeam is oriented perpendicular to the grating, wherein a first distal region of the photonic crystal cavity is affixed to a substrate; a piezoelectric component comprising a free-floating distal region connected to a second distal region of the photonic crystal cavity; and a voltage source configured to apply a voltage to the piezoelectric component, wherein applying the voltage to the piezoelectric component generates strain in the photonic crystal cavity.

In some embodiments, the piezoelectric component comprises: a piezoelectric layer comprising a piezoelectric material; and a pair of electrode layers sandwiching the piezoelectric layer. In some embodiments, the piezoelectric material comprises aluminum nitride. In some embodiments, the electrode layers comprise aluminum. In some embodiments, the photonic system further comprises: a second piezoelectric component cantilever disposed beneath and connected to a medial region of the photonic crystal cavity, wherein the voltage source is configured to apply a second voltage to the second piezoelectric component, wherein applying the second voltage to the piezoelectric component generates strain in the photonic crystal cavity.

In some embodiments, a pitch of the grating varies along a direction parallel to the longitudinal axis of the nanobeam. In some embodiments, the pitch of the grating increases from a medial region of the grating to distal regions of the grating. In some embodiments, the pitch of the grating decreases from a medial region of the grating to distal regions of the grating. In some embodiments, the variation in the pitch of the grating supports adiabatic mode conversion. In some embodiments, an adiabatic taper length of the grating is between 0 μm and 10 μm. In some embodiments, a thickness of the grating is between 100 nm and 300 nm. In some embodiments, a duty cycle of the grating is between 25% and 75%. In some embodiments, a width of the nanobeam varies along the longitudinal axis of the nanobeam. In some embodiments, the width of the nanobeam increases from a medial region of the nanobeam to distal regions of the nanobeam. In some embodiments, the width of the nanobeam decreases from a medial region of the nanobeam to distal regions of the nanobeam. In some embodiments, the nanobeam at a midpoint of the longitudinal axis of the nanobeam is between 150 nm and 600 nm. In some embodiments, a thickness of the nanobeam is between 50 nm and 300 nm. In some embodiments, the nanobeam comprises one or more quantum emitters. In some embodiments, an emitter mode of the one or more quantum emitters is spectrally aligned with a cavity mode associated with the photonic crystal cavity. In some embodiments, the second dielectric material is diamond. In some embodiments, the first dielectric material is silicon nitride. In some embodiments, the photonic crystal cavity is configured for in-plane coupling and a distal end of the nanobeam is optically coupled to an output waveguide. In some embodiments, the photonic crystal cavity is configured for out-of-plane coupling by alternating widths of the grating beams in an adiabatic taper region. In some embodiments, the photonic system further comprises a backplane disposed beneath the grating to redirect light upward from the cavity. In some embodiments, a mode volume of the photonic crystal cavity is less than 1.5 (λ/neff)³, wherein neff comprises an effective refractive index of a cavity mode associated with the photonic crystal cavity. In some embodiments, a quality factor of the photonic crystal cavity is greater than 10⁵.

In some embodiments, a method is provided, comprising: confining light to at least one region of a photonic crystal cavity comprising: a grating comprising a first dielectric material; a nanobeam comprising a second dielectric material deposited on a surface of the grating, wherein a longitudinal axis of the nanobeam is oriented perpendicular to the grating. In some embodiments, the at least one region comprises the nanobeam and the grating. In some embodiments, the at least one region comprises the nanobeam and an air gap between beams of the grating. In some embodiments, the method further comprises: transmitting light from a distal end of the nanobeam to an output waveguide that is optically coupled to receive light from the nanobeam. In some embodiments, the method further comprises: determining a cavity mode associated with the photonic crystal cavity; and tuning the cavity mode using a piezoelectric component connected to the photonic crystal cavity. In some embodiments, tuning the cavity using the piezoelectric component comprises: applying a voltage to the piezoelectric component based on the determined cavity mode.

In some embodiments, tuning the cavity using the piezoelectric component comprises tuning a zero-phonon line frequency of the emitter independently of the cavity mode. In some embodiments, the method further comprises spectrally aligning an emitter mode and a cavity mode associated with the photonic crystal cavity.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

This application contains at least one drawing executed in color. Copies of this patent application publication with color drawing(s) will be provided by the Office upon request and payment of the necessary fee.

The following figures show various hybrid photonic crystal cavities and systems comprising hybrid photonic crystal cavities. The devices and systems shown in the figures may have any one or more of the characteristics described herein.

FIG. 1A shows a top-down view of an apparatus that includes a hybrid photonic crystal cavity, according to some embodiments.

FIG. 1B shows a cross-sectional side view of an apparatus that includes a hybrid photonic crystal cavity, according to some embodiments.

FIG. 2A shows a top-down view of a hybrid photonic crystal cavity with a pitch defect in the grating that confines optical modes to the nanobeam and the grating, according to some embodiments.

FIG. 2B shows a top-down view of a hybrid photonic crystal cavity with a pitch defect in the grating that confines optical modes to the nanobeam and the air regions between the grating beams, according to some embodiments.

FIG. 2C shows a perspective view of a hybrid photonic crystal cavity with a pitch defect in the grating that confines optical modes to the nanobeam and the grating, according to some embodiments.

FIG. 2D shows a perspective view of a hybrid photonic crystal cavity with a pitch defect in the grating that confines optical modes to the nanobeam and the air regions between the grating beams, according to some embodiments.

FIG. 3A shows a top-down view of a hybrid photonic crystal cavity with a width defect in the nanobeam that confines the optical modes to the nanobeam and the grating, according to some embodiments.

FIG. 3B shows a top-down view of a hybrid photonic crystal cavity with a width defect in the nanobeam that confines the optical modes to the nanobeam and the air regions between the grating beams, according to some embodiments.

FIG. 3C shows a perspective view of a hybrid photonic crystal cavity with a width defect in the nanobeam that confines optical modes to the nanobeam and the grating, according to some embodiments.

FIG. 3D shows a perspective view of a hybrid photonic crystal cavity with a width defect in the nanobeam that confines optical modes to the nanobeam and the air regions between the grating beams, according to some embodiments.

FIG. 3E shows a pitch-defect hybrid cavity configuration for a dielectric optical mode, according to some embodiments.

FIG. 3F shows a width-defect hybrid cavity configuration for a dielectric optical mode, according to some embodiments.

FIG. 3G shows a representative unit cell of a hybrid cavity including a diamond nanobeam and patterned silicon nitride lines, according to some embodiments.

FIG. 3H shows an air-mode hybrid cavity configuration based on a pitch defect, according to some embodiments.

FIG. 3I shows an air-mode hybrid cavity configuration based on a width defect, according to some embodiments.

FIG. 4A shows example data relating the medial width of a nanobeam of a hybrid photonic crystal cavity to the cavity mode wavelength and quality factor of the crystal cavity, according to some embodiments.

FIG. 4B shows example data relating the medial width of a nanobeam of a hybrid photonic crystal cavity to the cavity mode wavelength and quality factor of the crystal cavity, according to some embodiments.

FIG. 5A shows electric field mode profiles for air mode hybrid photonic crystal cavities and dielectric mode hybrid photonic crystal cavities, according to some embodiments.

FIG. 5B shows a pitch-defect hybrid cavity configuration with a parabolic variation in grating pitch, according to some embodiments.

FIG. 5C shows a simulated fundamental transverse electric mode of the hybrid cavity of FIG. 5B, according to some embodiments.

FIG. 5D shows a simulated top-view field distribution of the cavity mode of FIG. 5C, according to some embodiments.

FIG. 5E shows a simulated side-view field distribution of the cavity mode of FIG. 5C, according to some embodiments.

FIG. 5F shows band diagrams for the silicon nitride grating and diamond nanobeam waveguide demonstrating the hybrid cavity bandgap, according to some embodiments.

FIG. 5G shows a schematic of Gaussian beam propagation simulations for a hybrid diamond nanobeam-silicon nitride grating cavity, according to some embodiments.

FIG. 5H shows a normalized transmission spectrum for the propagation simulations of FIG. 5G, according to some embodiments.

FIG. 5I shows extracted wavelength band edges from the propagation simulations of FIG. 5G, according to some embodiments.

FIG. 5J shows a schematic of a cavity simulation setup used to evaluate resonance wavelength and quality factor dependence on nanobeam width, according to some embodiments.

FIG. 5K shows example data relating the medial width of a nanobeam of a hybrid photonic crystal cavity to the cavity mode wavelength and quality factor of the crystal cavity, according to some embodiments.

FIG. 5L shows example data relating the medial width of a nanobeam of a hybrid photonic crystal cavity to the cavity mode wavelength and quality factor of the crystal cavity, according to some embodiments.

FIG. 6A shows a block diagram of a photonic system for facilitating in-plane optical coupling from a hybrid photonic crystal cavity, according to some embodiments.

FIG. 6B shows a photonic system with a waveguide that is coupled to receive light from one end of a nanobeam of a hybrid photonic crystal cavity, according to some embodiments.

FIG. 7A shows example data relating the number of mirror periods on the side of a photonic crystal cavity that is configured to output light out of one end of the nanobeam to a waveguide to the quality factor of the photonic crystal cavity and the percent light coupling out to the waveguide, according to some embodiments.

FIG. 7B shows simulated cavity quality factor as a function of mirror periods on the photon collection side of a dielectric pitch-defect cavity, according to some embodiments.

FIG. 7C shows the corresponding Purcell factor calculated from the simulated quality factors of FIG. 7B, according to some embodiments.

FIG. 7D shows example data from the same simulation as used in FIG. 7B relating the number of mirror periods on the side of a photonic crystal cavity that is configured to output light out of one end of the nanobeam to a waveguide to the total photon collection efficiency out of one end of the nanobeam waveguide of the photonic crystal cavity, according to some embodiments.

FIG. 8 shows a vertically-emitting hybrid photonic crystal cavity, according to some embodiments.

FIG. 9A shows an example far-field projection of the squared magnitude of the electromagnetic field from an emitter in a hybrid photonic crystal cavity that is optimized for quality factor, according to some embodiments.

FIG. 9B shows an example far-field projection of the squared magnitude of the electromagnetic field from an emitter in a hybrid photonic crystal cavity configured for out-of-plane coupling and has a grating perturbation applied on top of an adiabatic grating taper to direct light vertically, according to some embodiments.

FIG. 9C shows an example far-field projection of the squared magnitude of the electromagnetic field from an emitter in a hybrid photonic crystal cavity configured for out-of-plane coupling and includes a metal backplane to minimize loss of emitter light into the substrate, according to some embodiments.

FIG. 9D shows a schematic of a pitch-defect hybrid cavity with grating perturbation applied on top of an adiabatic grating taper to configure the cavity for vertical out-coupling of light, according to some embodiments.

FIG. 9E shows a far-field profile of the squared electric field magnitude for a quality factor optimized hybrid cavity, according to some embodiments.

FIG. 9F shows a far-field profile of the squared electric field magnitude for a hybrid cavity with grating line perturbation applied, configured for vertical out-coupling of light according to some embodiments.

FIG. 9G shows a far-field profile of the squared electric field magnitude for a hybrid cavity with grating line perturbation applied and with a backplane to enhance vertical emission, according to some embodiments.

FIG. 10A shows a block diagram of a photonic system for piezoelectrically tuning a hybrid photonic crystal cavity, according to some embodiments.

FIG. 10B shows a side view of a system for piezoelectrically tuning hybrid photonic crystal cavity, according to some embodiments.

FIG. 10C shows an example of a system for piezoelectrically tuning a hybrid photonic crystal cavity, according to some embodiments.

FIG. 10D shows an example of a system for piezoelectrically tuning a hybrid photonic crystal cavity, according to some embodiments.

FIG. 10E shows simulated strain profiles generated by a zero-phonon line tuner under applied voltages, according to some embodiments.

FIG. 10F shows simulated displacement profiles of a hybrid cavity structure under cantilever actuation, according to some embodiments.

FIG. 11A shows example data relating the voltage applied to a piezoelectric actuator in a piezoelectrically actuated hybrid photonic crystal cavity to the frequency shift in the cavity mode relative to zero applied voltage and to the quality factor of the crystal cavity, according to some embodiments.

FIG. 11B shows example data relating the voltage applied to a piezoelectric actuator in a piezoelectrically actuated hybrid photonic crystal cavity frequency shift in the cavity mode relative to zero applied voltage and to the quality factor of the crystal cavity, according to some embodiments.

FIG. 12A shows SEM images of a diamond chiplet with nanobeams transferred onto a silicon nitride grating to form hybrid photonic crystal cavities, according to some embodiments.

FIG. 12B shows a measured emission spectrum from a nanobeam waveguide of the chiplet of FIG. 12A with resonant peaks indicating cavity modes, according to some embodiments.

FIG. 12C shows a measured emission spectrum from another nanobeam waveguide of the chiplet of FIG. 12A with resonant peaks at shifted wavelengths, according to some embodiments.

### DETAILED DESCRIPTION

Described herein are examples of systems, devices, and methods utilizing hybrid photonic crystal (PhC) cavities that include a nanobeam of a first dielectric material (for example, a diamond waveguide) disposed on a surface of a grating formed from a second dielectric material (for example, silicon nitride). These hybrid PhC cavities can be formed using reliable and standardized semiconductor processing techniques by placing a nanobeam of a first dielectric material onto a grating of a second dielectric material.

Imposing geometric defects (for example, defects in the pitch of the grating or in the width of the nanobeam) in the nanobeam or the grating can change the cavity regions to which optical modes are confined. Since such defects can be easily manufactured in many semiconductor materials, the cavities can be fabricated for a variety of use cases without requiring the use of specialized or non-standardized processes.

The hybrid PhC cavities can be straightforwardly integrated into larger photonic devices and systems. For example, a hybrid PhC cavity can be configured to optically couple to transmit light from a distal end of the nanobeam to an underlying output waveguide. A hybrid PhC cavity can also be configured for out-of-plane optical coupling. The disclosed PhC cavities can therefore be utilized for a number of complex photonic applications. In particular, quantum processors can include a nanobeam fabricated with embedded quantum emitters (e.g., color centers or quantum dots), and the optical modes of the emitters and the cavity mode can be spectrally aligned to one another and to other optical components, allowing for improved efficiency of generation of identical emitters for high-fidelity quantum information processing.

The following description is presented to enable a person of ordinary skill in the art to make and use the various embodiments and aspects thereof disclosed herein. Descriptions of specific devices, assemblies, techniques, and applications are provided only as examples. Various modifications to the examples described herein will be readily apparent to those of ordinary skill in the art, and the general principles described herein may be applied to other examples and applications without departing from the spirit and scope of the various embodiments and aspects thereof. Thus, the various embodiments and aspects thereof are not intended to be limited to the examples described herein and shown but are to be accorded the scope consistent with the claims.

Any of the systems, methods, techniques, and/or features disclosed herein may be combined, in whole or in part, with any other systems, methods, techniques, and/or features disclosed herein.

Reference to “about” or “approximately” a value or parameter herein includes (and describes) variations of that value or parameter per se. For example, description referring to “approximately X” or “about X” includes description of “X” as well as variations of “X”.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

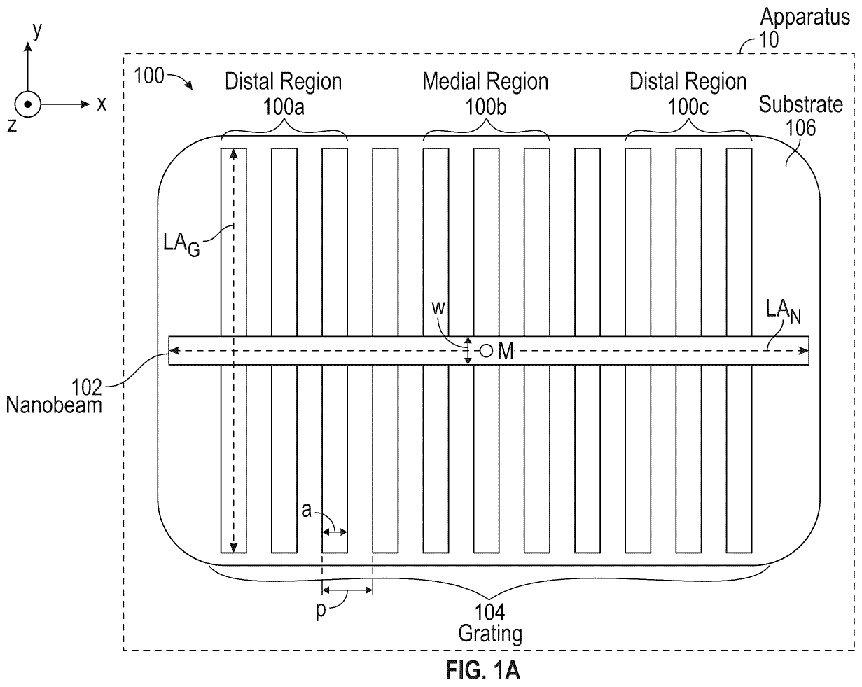

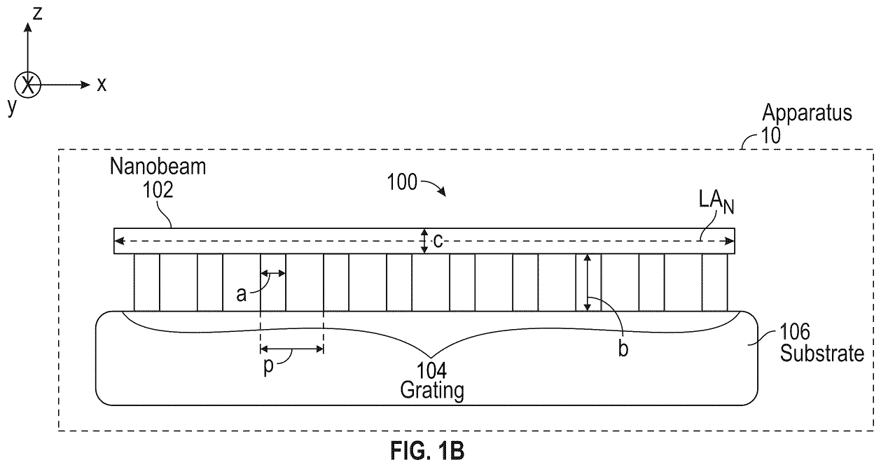

Top-down and cross-sectional side views of an exemplary apparatus 10 that includes hybrid photonic crystal (PhC) cavity 100 are shown in FIG. 1A and FIG. 1B, respectively. PhC 100 can include a grating 104 that is made up of a plurality of parallel beams formed from a first dielectric material and a nanobeam 102 that is deposited on a surface of grating 104 and is formed from a second dielectric material that is different from the first dielectric material from which the beams of the grating 104 are formed. Nanobeam 102 can be oriented relative to grating 104 such that the longitudinal axis of nanobeam 102 (labeled LA_{N} in FIGS. 1A-1B) is at a non-parallel angle, for example orthogonal or approximately orthogonal, to the longitudinal axes of the beams (labeled LA_{G} in FIG. 1A) that constitute grating 104. Orthogonal arrangements may provide the highest quality factor in the cavity.

Different angles may be used for coupling the output from the nanobeam to an underlying on-chip waveguide (e.g., a SiN waveguide) at a particular angle.

Apparatus 10 can be any apparatus that includes PhC cavity 100. In some embodiments, apparatus 10 is a wafer or a chip that includes only PhC cavity 100. In these embodiments, apparatus 10 can be added to a larger photonic system or device so that PhC cavity 100 can be optically coupled to components of the system or device. For example, apparatus 10 can be configured to be combined with other electrical and optical components to form a processor. In other embodiments, apparatus 10 can be a device that includes PhC cavity 100 as well as additional electrical or optical components. For example, apparatus 10 can be a quantum computer, a device in a spectroscopy system, or a device in an optical filtering system.

The dielectric material from which grating 104 is formed can be any suitable dielectric material. Example dielectric materials include (but are not limited to) silicon nitride (SiN), Si, and/or SiO2. The material may be CMOS compatible, which makes it ideal for scalability of the structure. In some embodiments, any low-loss dielectric could be used. In some embodiments, the material for grating 104 is distinct from the material from which the nanobeam is formed, such that a refractive index contrast generates a spatially confined cavity mode.

Each beam that constitutes grating 104 can have a width a (see FIG. 1A). The width of each beam in grating 104 can be between 1 and 50 nm, between 2 and 35 nm, between 3 and 25 nm, between 4 and 15 nm, between 5 and 10 nm, or between 150 and 600 nm. In some embodiments, the width of each beam in grating 104 is approximately 1 nm, approximately 2 nm, approximately 3 nm, approximately 4 nm, approximately 5 nm, approximately 6 nm, approximately 7 nm, approximately 8 nm, approximately 9 nm, approximately 10 nm, 25 nm, 50 nm, 100 nm, 150 nm, 200 nm, 300 nm, 400 nm, 500 nm, 600 nm, 700 nm, 800 nm, or 1000 nm. In other embodiments, the width of each beam in grating 104 is less than 1 nm or greater than 1000 nm. Beam width can range from as small as the fabrication tolerance to as large as needed for a given use case.

The beams of grating 104 can have a cross-sectional thickness b (see FIG. 1B). The cross-sectional thickness of each grating beam can be between 50 nm and 500 nm, between 75 nm and 400 nm, between 100 nm and 300 nm, or between 100 nm and 200 nm. For example, the cross-sectional thickness of each grating beam can be approximately 90 nm, approximately 100 nm, approximately 110 nm, approximately 120 nm, approximately 130 nm, approximately 140 nm, approximately 150 nm, approximately 160 nm, approximately 170 nm, approximately 180 nm, approximately 190 nm, approximately 200 nm, or approximately 210 nm. In some embodiments, the cross-sectional thickness of each grating beam is less than 50 nm or greater than 500 nm.

Grating 104 can have a pitch p, which is the distance between corresponding locations of adjacent beams such as the center-to-center distance along the direction parallel to the longitudinal axis of nanobeam 102 (LA_{N}). The pitch of grating 104 can be between 50 nm and 500 nm, between 75 nm and 450 nm, between 100 nm and 400 nm, between 125 nm and 350 nm, between 150 nm and 300 nm, between 150 nm and 250 nm, or between 150 nm and 240 nm. For example, the pitch of grating 104 can be approximately 140 nm, approximately 150 nm, approximately 160 nm, approximately 170 nm, approximately 180 nm, approximately 190 nm, approximately 200 nm, approximately 210 nm, approximately 220 nm, approximately 230 nm, approximately 240 nm, approximately 250 nm, or approximately 260 nm. In some embodiments, the pitch of grating 104 is less than 50 nm or greater than 500 nm. Pitch can range from as small as the fabrication tolerance to as large as needed for a given use case. Pitch may be scaled based on desired cavity mode wavelength. A larger pitch may be used to give cavity modes at longer wavelengths, and vice-versa. For some applications with diamond quantum emitters in the visible wavelength range (˜500-800 nm), pitch may be between 150 and 220 nm. Exact pitch may be chosen to achieve desired cavity mode wavelength/frequency and may depend on other geometric parameters such as waveguide/nanobeam height and width.

Grating 104 can include between 10 and 40, between 5 and 50, between 5 and 40, between 5 and 30, between 5 and 20, or between 5 and 10 pitches between a midpoint M of PhC 100 and a distal edge of PhC 100. For example, grating 104 can include 5, 6, 7, 8, 9, 10, 15, 20, 25, 30, 35, 40, 45, or 50 pitches between midpoint M of PhC 100 and a distal edge of PhC 100. The duty cycle of grating 104 (that is, the ratio of the width a of the grating beams to the pitch p of grating 104) can be between 25% and 75%, for example approximately 50%.

Grating 104 can include between 10 and 40, between 5 and 50, between 5 and 40, between 5 and 30, between 5 and 20, or between 5 and 10 pitches in a taper region between a midpoint M of PhC 100 and a distal region 100a or 100c. For example, grating 104 can include 5, 6, 7, 8, 9, 10, 15, 20, 25, 30, 35, 40, 45, or 50 pitches between midpoint M of PhC 100 and either distal region 100a or 100c. In some implementations, the number of grating periods (e.g., pitches) between a midpoint of grating 104 and an edge of grating 104 may be between 5 and 30. In some implementations, the number of grating periods may be between 5 and 60. For example, the number of grating periods may be at least 5, at least 10, at least 20, at least 30, at least 40, at least 50, at least 60, at most 60, at most 50, at most 40, at most 30, at most 20, at most 10, or at most 5. In this dielectric-mode configuration, the optical field is primarily confined within the diamond waveguide and the silicon nitride grating regions, providing overlap with both materials to enable interaction with adjacent photonic components.

Grating 104 can include between 20 to 60, between 10 and 40, between 5 and 50, between 5 and 40, between 5 and 30, between 5 and 20, or between 5 and 10 pitches in a distal region 100a or 100c. For example, grating 104 can include 5, 6, 7, 8, 9, 10, 15, 20, 25, 30, 35, 40, 45, 50, 55, 60, 65, 70, or 75 pitches in a distal region 100a or 100c.

Adjustments to the numbers of pitches in one or more of the regions described above may affect the quality factor of the cavity, emitter enhancement, and/or the percent of light output along the nanobeam. All these values may be tailored and optimized for a desired application.

In some embodiments, the pitch in one or more of the regions described above may be variable. In some embodiments in which the pitch is variable, the duty cycle may remain constant across the pitches. For example, 50% duty cycle with center pitch of 170 nm would alternate 170/2 nm with SiN nanoline, then 170/2 nm gap, and so on. As the pitch tapers larger or smaller, the duty cycle may stay 50% with the width of each beam being pitch/2 nm and an air gap of pitch/2 nm. In some embodiments, a grating with a fixed pitch where only duty cycle is varied from the medial region to the distal region could be made, and a similar cavity mode confinement can be achieved.

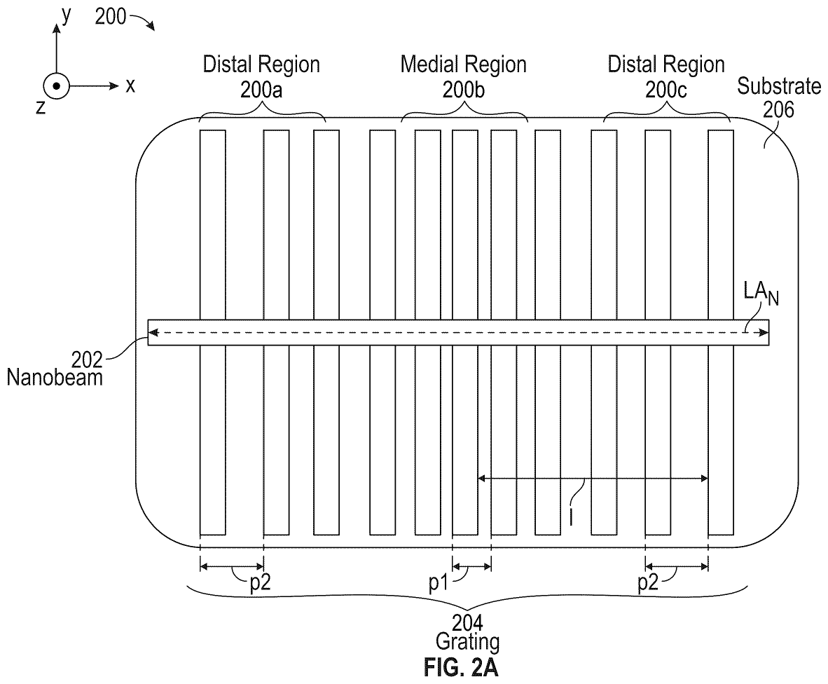

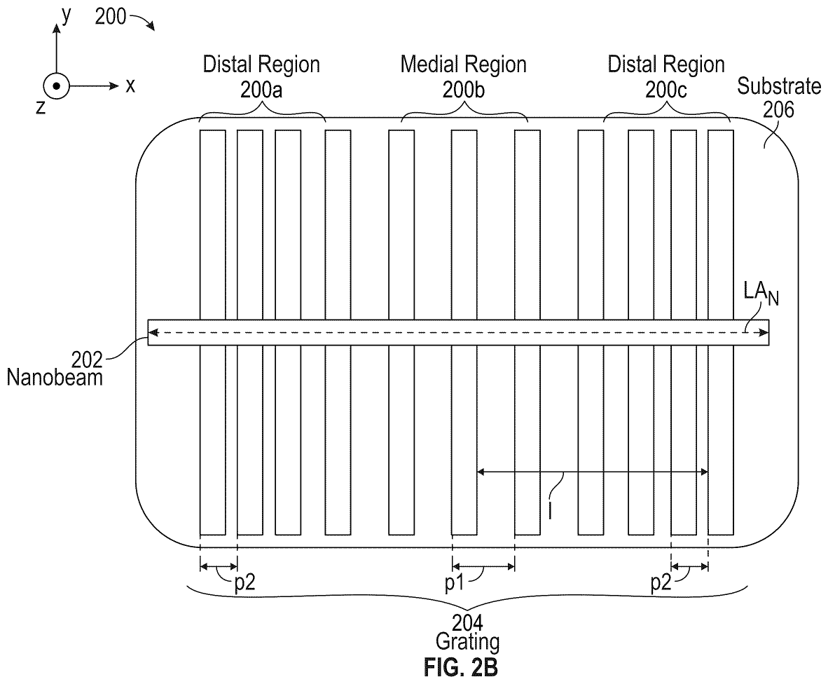

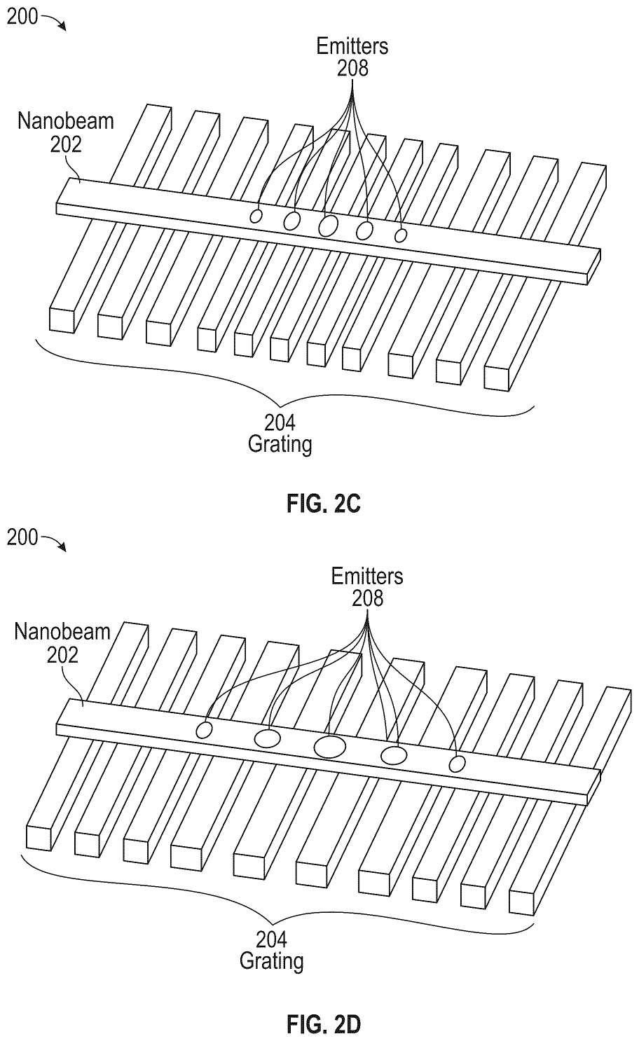

In some embodiments, the pitch of grating 104 is constant. In other embodiments, the pitch of grating 104 varies. For example, the pitch of grating 104 can be greater in the distal regions 100a and 100c of PhC crystal 100 than in a medial region 100b of PhC crystal 100. Alternatively, the pitch of grating 104 in the distal regions 100a and 100c of PhC crystal 100 can be less than the pitch of grating 104 in the medial region 100b of PhC crystal 100. The effects of variable grating pitch (referred to herein as a pitch defect) on the optical properties of grating 104 are discussed in further detail with reference to FIGS. 2A-2D.

The dielectric material from which nanobeam 102 is formed can be any suitable dielectric material that is distinct from the dielectric material from which grating 104 is formed. Example dielectric materials include (but are not limited to) diamond, Gallium Arsenide, and/or indium phosphide. If the relative refractive index between the nanobeam and the grating if very different, it may be difficult (though still possible) to set up a geometry that provides good cavity mode confinement.

Nanobeam 102 can have a width w (see FIG. 1A). For example, as shown in FIG. 1A, this width may be the width of the nanobeam at the midpoint of the longitudinal axis. The width of nanobeam 102 can be between 50 nm and 1000 nm, between 100 nm and 800 nm, between 150 nm and 600 nm, between 150 nm and 500 nm, or between 200 nm and 300 nm. For example, the width of nanobeam 102 can be approximately 150 nm, approximately 250 nm, approximately 350 nm, approximately 450, or approximately 550 nm. In some embodiments, the width of nanobeam 102 is less than 50 nm or greater than 1000 nm.

The width of the nanobeam can, in some embodiments, be as small as fabrication tolerances permit, and as large as desired for a given use case. The size of the nanobeam may be scaled based on desired cavity mode wavelength. A wider nanobeam may be used to give cavity modes at longer wavelengths, and vice-versa. For applications with diamond quantum emitters in the visible wavelength range (˜500-800 nm), nanobeam width may be between 100 and 1000 nm. Exact nanobeam width may be chosen to achieve desired cavity mode wavelength/frequency, and may depend on the other geometric parameters such as nanobeam height and grating pitch.

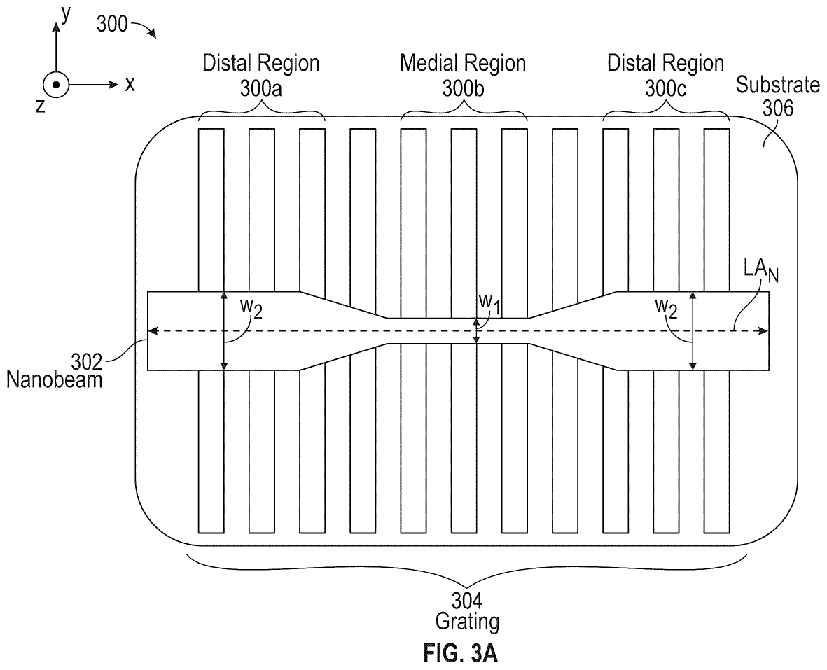

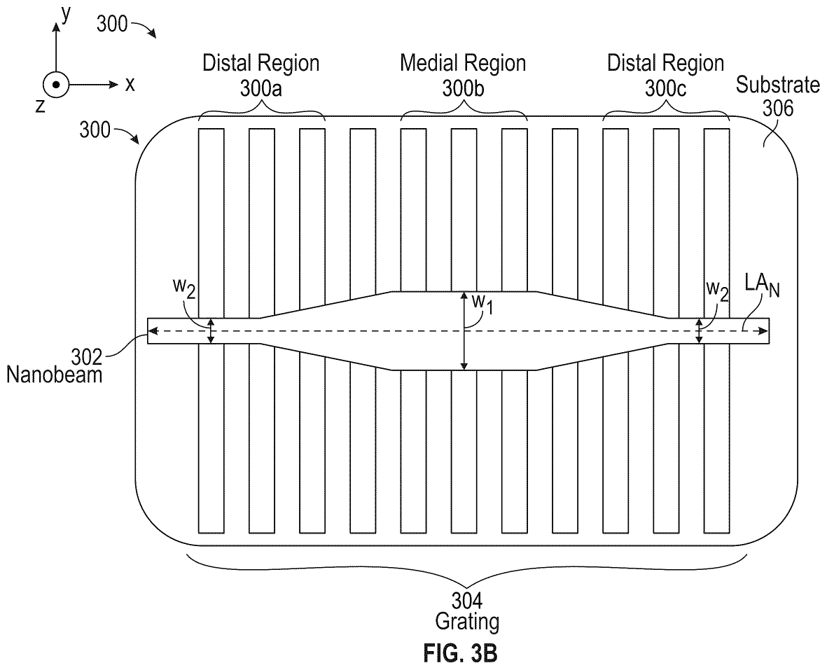

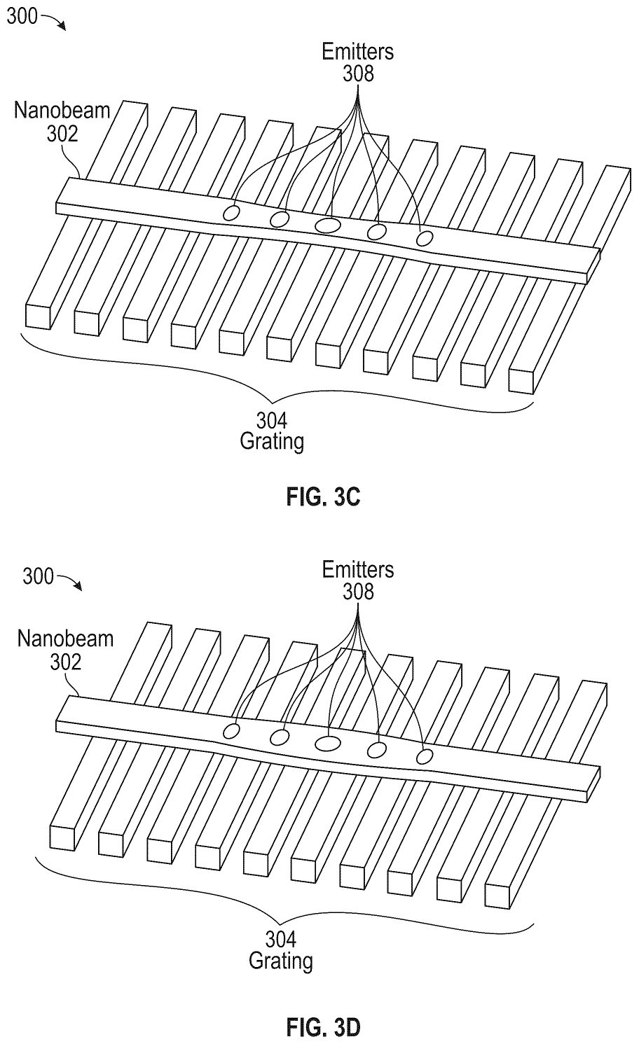

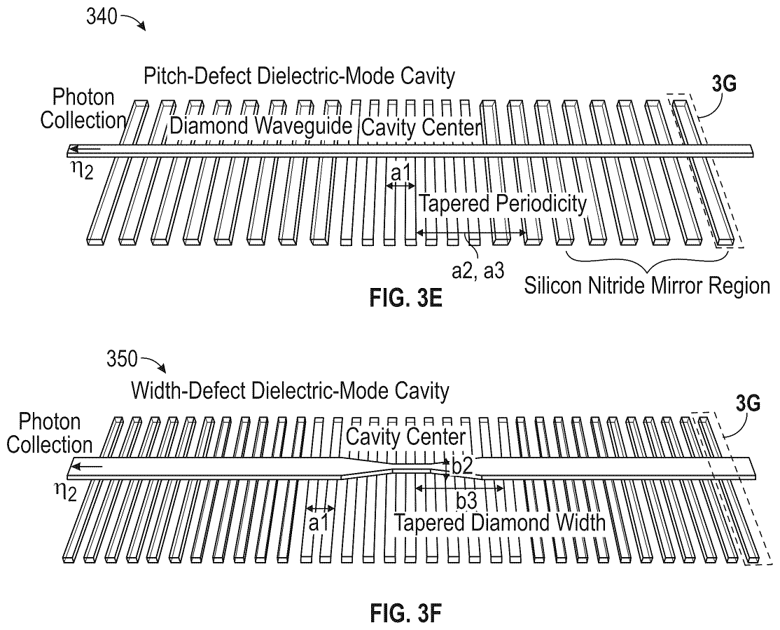

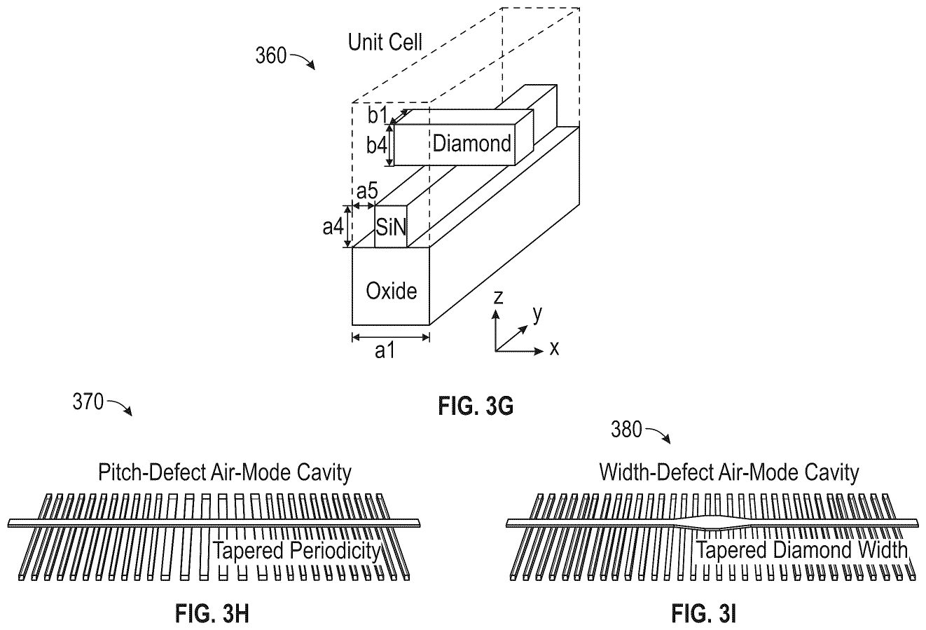

In some embodiments, the width of nanobeam 102 is constant along the longitudinal axis of nanobeam 102 (LA_{N}). In other embodiments, the width of nanobeam 102 varies along the longitudinal axis of nanobeam 102 (LA_{N}). For example, the width of nanobeam 102 can be greater in the distal regions 100a and 100c of PhC crystal 100 than in a medial region 100b of PhC crystal 100. Alternatively, the width of nanobeam 102 in the distal regions 100a and 100c of PhC crystal 100 can be less than the width of nanobeam 102 in the medial region 100b of PhC crystal 100. The effects of non-constant nanobeam width (referred to herein as a width defect) on the optical properties of grating 104 are discussed in further detail with reference to FIGS. 3A-3D.

Nanobeam 102 can have a cross-sectional thickness c. The cross-sectional thickness of nanobeam 102 can be between 25 nm and 250 nm, between 50 nm and 225 nm, between 50 nm and 200 nm, between 25 nm and 300 nm, between 50 nm and 300 nm, between 50 nm and 200 nm, between 75 nm and 150 nm, between 100 nm and 150 nm, between 100 nm and 200 nm, or between 100 nm and 300 nm. For example, the cross-sectional thickness of nanobeam 102 can be approximately 40 nm, approximately 50 nm, approximately 60 nm, approximately 70 nm, approximately 80 nm, approximately 90 nm, approximately 100 nm, approximately 120 nm, approximately 140 nm, approximately 160 nm, approximately 180 nm, approximately 200 nm, or approximately 220 nm. In some embodiments, nanobeam 120 has a cross-sectional thickness that is less than 25 nm or greater than 250 nm.

PhC crystal 100 can be fabricated using a semiconductor fabrication process (e.g., a CMOS fabrication process). Grating 104 and nanobeam 102 can be deposited on a surface of a substrate 106, e.g., a silicon dioxide (SiO₂) substrate. For example, nanobeam 102 can be heterogeneously integrated via direct placement on a layer stack patterned with grating 104 on a silicon wafer (substrate 106). Substrate 106 can host optical or electronic components in addition to PhC crystal 100, for instance waveguides, optical sources (e.g., lasers), or sensors.

### Optical Properties of Hybrid PhC Cavities

A nanobeam of a hybrid PhC cavity (e.g., nanobeam 102 of hybrid PhC cavity 100 shown in FIGS. 1A-1B) can be an optical component that is configured to transmit optical signals. For example, the nanobeam can be a waveguide. An optical mode can be naturally confined laterally (e.g., in the y direction indicated in FIGS. 1A-1B) and vertically (e.g., in the z direction indicated in FIGS. 1A-1B) by the nanobeam. Evanescent fields of optical signals in the nanobeam can interact with the underlying grating (e.g., grating 104 of PhC cavity 100). The patterning of the grating and the underlying substrate (e.g., substrate 106 of PhC cavity 100) can generate air gaps and form lines of a specified pitch to generate a distributed Bragg mirror. Depending on the specific patterning, in addition to its natural confinement in the nanobeam, the optical mode can be confined to either the air gaps or to the grating beams.

As noted above, the nanobeam may be a waveguide. In some embodiments, the term waveguide may refer to a rectangular structure that can confine and transmit light along it. The nanobeam combined with the grating may create a cavity mode where light from an emitter can emit in all directions. By decreasing the distal region on one side, light from the emitter may be transmitted along the nanobeam, so it is acting as a waveguide in that situation. In many geometric configurations, the nanobeam may behave as a waveguide. In some geometric configurations, the nanobeam may not behave as a waveguide.

### Pitch Defects

FIGS. 2A-2D show various views of a hybrid PhC cavity 200 that has a pitch defect, that is, a hybrid PhC cavity 200 in which the grating 204 has a varying pitch. In some embodiments, as depicted in FIGS. 2A and 2C, the pitch of grating 204 increases from a medial region of PhC cavity 200 (labeled 200b in FIG. 2A) to the distal regions of PhC cavity 200 (labeled 200a and 200c in FIG. 2A). In other embodiments, as depicted in FIGS. 2B and 2D, the pitch of grating 204 decreases from the medial region of PhC cavity 200 (labeled 200b in FIG. 2B) to the distal regions of PhC cavity 200 (labeled 200a and 200c in FIG. 2B).

In embodiments in which the pitch increases from the center of PhC cavity 200 (FIGS. 2A and 2C), an optical mode in the nanobeam 202 of PhC cavity 200 is confined to nanobeam 202 and the beams of grating 204. In other words, when the pitch of grating 204 increases from the center of PhC cavity 200, the optical mode is a “dielectric mode” that is confined to the dielectric materials of PhC cavity 200. In these embodiments, grating 204 may have a first pitch p₁ in the medial region 200b of PhC cavity 200 and a second pitch p₂ in the distal regions 200a and 200c of PhC cavity 200. p₁ can be less than or approximately equal to 0.95 p₂, 0.9 p₂, 0.85 p₂, 0.8 p₂, 0.75 p₂, 0.7 p₂, 0.65 p₂, 0.6 p₂, 0.55 p₂, 0.5 p₂, 0.45 p₂, 0.4 p₂, 0.35 p₂, 0.3 p₂, or 0.25 p₂. The pitch of grating 204 can taper adiabatically between distal regions 200a/200c and medial region 200b. The adiabatic taper length of grating 204 (that is, the length over which the pitch of grating changes from p₁ to p₂, labeled l in FIG. 2A) may be between 1 and 50 nm, between 2 and 40 nm, between 3 and 30 nm, between 4 and 20 nm, or between 5 and 15 nm. For example, the adiabatic taper length of grating 204 can be approximately 5 nm, approximately 6 nm, approximately 7 nm, approximately 8 nm, approximately 9 nm, approximately 10 nm, approximately 11 nm, approximately 12 nm, approximately 13 nm, approximately 14 nm, or approximately 15 nm. In some implementations, the adiabatic taper length of grating 204 may be between 1 and 50 μm, between 2 and 40 μm, between 3 and 30 μm, between 4 and 20 μm, or between 5 and 15 μm. For example, the adiabatic taper length of grating 204 can be approximately 5 μm, approximately 6 μm, approximately 7 μm, approximately 8 μm, approximately 9 μm, approximately 10 μm, approximately 11 μm, approximately 12 μm, approximately 13 μm, approximately 14 μm, or approximately 15 μm. In some implementations, the adiabatic taper length of grating 204 may be between 0 and 20 μm. In some implementations, the adiabatic taper length of grating 204 may be between 0 and 10 μm. For example, the adiabatic taper length of grating 204 may be 8 μm. In some embodiments in a “pitch defect, dielectric mode” configuration, a pitch value at the center of the cavity may be about 170 nm, and a pitch value at edges of the cavity may be about 180 nm.

Adiabatic taper length may refer to the length over which the grating pitch changes from the center of the cavity to the distal region (e.g., to an interior edge of the distal region). Taper may not be adiabatic in some embodiments, but adiabatic type tapering may provide the best quality factor cavity. Adiabatic tapering may refer to a gradual adjustment to the geometry, which may preserve cavity mode shape and quality. For example, tapering the grating pitch adiabatically may support adiabatic mode conversion. Non-adiabatic taper may be used in some embodiments, providing a more abrupt geometric change (such as having the pitch of the grating change suddenly from 180 to 190 nm without a gradual change). Non-adiabatic arrangements may still make a cavity, but may provide a lower quality factor.

In embodiments in which the pitch decreases from the center of PhC cavity 200 (FIGS. 2B and 2D), an optical mode in nanobeam 202 is confined to nanobeam 202 and the air gaps between the beams that constitute grating 204. In other words, when the pitch of grating 204 decreases from the center of PhC cavity 200, the optical mode is an “air mode” that is confined to nanobeam 202 and the areas that lack grating material. In these embodiments, grating 204 may have a first pitch p₁ in the medial region 200b of PhC cavity 200 and a second pitch p₂ in the distal regions 200a and 200c of PhC cavity 200. p₂ can be less than or approximately equal to 0.95 p₁, 0.9 p₁, 0.85 p₁, 0.8 p₁, 0.75 p₁, 0.7 p₁, 0.65 p₁, 0.6 p₁, 0.55 p₁, 0.5 p₁, 0.45 p₁, 0.4 p₁, 0.35 p₁, 0.3 p₁, or 0.25 p₁. The pitch of grating 204 can taper adiabatically between distal regions 200a/200c and medial region 200b. The adiabatic taper length of grating 204 (that is, the length over which the pitch of grating changes from p₁ to p₂, labeled l in FIG. 2B) may be between 1 and 50 nm, between 2 and 40 nm, between 3 and 30 nm, between 4 and 20 nm, or between 5 and 15 nm. For example, the adiabatic taper length of grating 204 can be approximately 5 nm, approximately 6 nm, approximately 7 nm, approximately 8 nm, approximately 9 nm, approximately 10 nm, approximately 11 nm, approximately 12 nm, approximately 13 nm, approximately 14 nm, or approximately 15 nm. In some embodiments in a “pitch defect, air mode” configuration, a pitch value at the center of the cavity may be about 190 nm, and a pitch value at edges of the cavity may be about 180 nm. In some implementations, the adiabatic taper length of grating 204 may be between 1 and 50 μm, between 2 and 40 μm, between 3 and 30 μm, between 4 and 20 μm, or between 5 and 15 μm. For example, the adiabatic taper length of grating 204 can be approximately 5 μm, approximately 6 μm, approximately 7 μm, approximately 8 μm, approximately 9 μm, approximately 10 μm, approximately 11 μm, approximately 12 μm, approximately 13 μm, approximately 14 μm, or approximately 15 μm. In some implementations, the adiabatic taper length of grating 204 may be between 0 and 20 μm. In some implementations, the adiabatic taper length of grating 204 may be between 0 and 10 μm. For example, the adiabatic taper length of grating 204 may be 8 μm. In some embodiments in a “pitch defect, air mode” configuration, a pitch value at the center of the cavity may be about 190 μm, and a pitch value at edges of the cavity may be about 180 μm.

As shown in FIGS. 2C-2D, nanobeam 202 can include one or more quantum emitters 208. The overlap between grating 204 and emitters 208 may be greater when PhC cavity 200 is a dielectric mode cavity (that is, when the pitch of grating 204 increases from the center of cavity 200) than the overlap between grating 204 and emitters 208 may be greater when PhC cavity 200 is an air mode cavity (that is, when the pitch of grating 204 decreases from the center of cavity 200). Greater overlap between emitters 208 and grating 204 can enhance the optical effects of the grating material. If the optical effects of grating 204 are desired for a particular application, then a dielectric mode cavity may be used. If the optical effects of grating 204 are not desired (e.g., if grating 204 amplifies or excites a source of optical noise in an optical system that includes PhC cavity 200), then an air mode cavity may be used.

### Width Defects

FIGS. 3A-3D show various views of a hybrid PhC cavity 300 that has a width defect, that is, a hybrid PhC cavity 300 in which the nanobeam 302 has a varying width. In some embodiments, as depicted in FIGS. 3A and 3C, the width of nanobeam 302 increases from a medial region of PhC cavity 300 (labeled 300b in FIG. 3A) to the distal regions of PhC cavity 300 (labeled 300a and 300c in FIG. 3A). In other embodiments, as depicted in FIGS. 3B and 3D, the width of nanobeam 302 decreases from the medial region of PhC cavity 300 (labeled 300b in FIG. 3B) to the distal regions of PhC cavity 300 (labeled 300a and 300c in FIG. 3B).

In embodiments wherein the nanobeam width increases from the center of PhC cavity 300 (FIGS. 3A and 3C), an optical mode in the nanobeam 302 of PhC cavity 300 is confined to nanobeam 302 and the beams of grating 304. In other words, when the width of nanobeam 302 increases from the center of PhC cavity 300, the optical mode is a “dielectric mode” that is confined to the dielectric materials of PhC cavity 300. In these embodiments, nanobeam 302 may have a first width w₁ in the medial region 300b of PhC cavity 300 and a second width w₂ in the distal regions 300a and 300c of PhC cavity 300. w₁ can be less than or approximately equal to 0.95 w₂, 0.9 w₂, 0.85 w₂, 0.8 w₂, 0.75 w₂, 0.7 w₂, 0.65 w₂, 0.6 w₂, 0.55 w₂, 0.5 w₂, 0.45 w₂, 0.4 w₂, 0.35 w₂, 0.3 w₂, or 0.25 w₂. In some embodiments in a “width defect, dielectric mode” configuration, a nanobeam width value at the center of the cavity may be about 300 nm, and a nanobeam width value at edges of the cavity may be about 400 nm.

In some embodiments, a parameter b2 may refer to a waveguide taper to edge difference, and may refer to the change in width of the nanobeam going from the center of the cavity to the distal region. For example, if the central width of the nanobeam is 300 nm and in the distal region width is 280 nm, then b2 is −20 nm. In some implementations, the waveguide taper to edge difference may be between at least 0 nm, at least 50 nm, at least 100 nm, at least 150 nm, at least 200 nm, at least 250 nm, at least 300 nm, at least 350 nm, at least 400 nm, at least 450 nm, at least 500 nm, at least 550 nm, at least 600 nm, at most 600 nm, at most 550 nm, at most 500 nm, at most 450 nm, at most 400 nm, at most 350 nm, at most 300 nm, at most 250 nm, at most 200 nm, at most 150 nm, at most 100 nm, at most 50 nm, or at most 0 nm. For example, the waveguide taper to edge difference may be between 0 and 400 nm.

In some embodiments, a parameter b3 may refer to a length along the nanobeam over which the taper takes place. For example, if a change from 300 nm to 280 nm occurs over 2 μm from center to mirror region on each side of the cavity, then b3 is 2 μm.

In embodiments in which the nanobeam width decreases from the center of PhC cavity 300 (FIGS. 3A and 3C), an optical mode in the nanobeam 302 of PhC cavity 300 is confined to nanobeam 302 and the air gaps between beams of grating 304. In other words, when the width of nanobeam 302 decreases from the center of PhC cavity 300, the optical mode is an “air mode” that is confined to nanobeam 302 and the areas that lack grating material. In these embodiments, nanobeam 302 may have a first width w₁ in the medial region 300b of PhC cavity 300 and a second width w₂ in the distal regions 300a and 300c of PhC cavity 300. w₂ can be less than or approximately equal to 0.95 w₁, 0.9 w₁, 0.85 w₁, 0.8 w₁, 0.75 w₁, 0.7 w₁, 0.65 w₁, 0.6 w₁, 0.55 w₁, 0.5 w₁, 0.45 w₁, 0.4 w₁, 0.35 w₁, 0.3 w₁, or 0.25 w₁. In some embodiments in a “width defect, air mode” configuration, a nanobeam width value at the center of the cavity may be about 600 nm, and a nanobeam width value at edges of the cavity may be about 400 nm.

As shown in FIGS. 3C-3D, nanobeam 302 can include one or more quantum emitters 308. The overlap between grating 304 and emitters 308 may be greater when PhC cavity 300 is a dielectric mode cavity (that is, when the width of nanobeam 302 increases from the center of cavity 300) than the overlap between grating 304 and emitters 308 may be greater when PhC cavity 300 is an air mode cavity (that is, when the width of nanobeam 302 decreases from the center of cavity 300). Greater overlap between emitters 308 and grating 304 can enhance the optical effects of the grating material. If the optical effects of grating 304 are desired for a particular application, then a dielectric mode cavity may be used. If the optical effects of grating 304 are not desired (e.g., if grating 304 amplifies or excites a source of optical noise in an optical system that includes PhC cavity 300), then an air mode cavity may be used.

FIGS. 3E-3I depict additional views of hybrid photonic crystal cavity geometries. Each hybrid cavity may include a diamond waveguide disposed on a patterned silicon nitride grating, which together may form a coupled resonant structure. The diamond waveguide may provide lateral and vertical confinement. The silicon nitride grating may establish a longitudinal photonic bandgap that may define mirror regions outside a defect region that support the cavity mode.

FIG. 3E depicts a pitch-defect configuration 340 for a dielectric optical mode. In this arrangement, the periodicity of the silicon nitride grating tapers from a smaller pitch proximate a medial region of the cavity to a larger pitch toward the distal mirror regions. The taper can be implemented over a defined number of grating periods to preserve mode shape and maintain a high quality factor.

FIG. 3F depicts a width-defect configuration 350 for a dielectric optical mode. In configuration 350, the width of the diamond waveguide increases from a narrower central width to a wider width toward the distal regions, while the grating pitch remains fixed. The gradual width variation admits a dielectric band within the surrounding bandgap thereby forming the cavity. As in configuration 340 of FIG. 3E, the resulting cavity mode may be confined to the diamond waveguide and the silicon nitride grating regions. The width-defect approach can be used when the grating is fixed, with coarse tuning achieved by selecting a diamond waveguide width. In some implementations, the change in waveguide width may be defined as a continuous function by replacing the integer j in the taper equations described above (e.g., parabolic taper function a^{(j)}=a1+a2 (j/a3)² and/or Gaussian taper function a^{(j)}=a−(a−a1) exp(−j²/(2σ²)) with the distance x from the center of the cavity. In such an implementation, a3 may represent the distance over which the width taper occurs, and σ may similarly represent the length of the taper from the center width to the mirror width.

FIG. 3G depicts a representative unit cell 360 of the hybrid cavity, including a diamond nanobeam aligned across patterned silicon nitride lines on a silicon dioxide layer above a silicon substrate. As shown in FIGS. 3E-3G, multiple geometric parameters can be selected to set the cavity resonance and coupling characteristics, including diamond waveguide center width b1, change in diamond waveguide width from center to mirror over taper region b2, diamond waveguide taper length b3, diamond waveguide height b4, central grating pitch a1, change in grating pitch from center to mirror over taper region a2, number of periods in grating taper a3, silicon nitride thickness a4, and grating fill factor a5. In some implementations, pitch-defect designs may vary a2 and a3 with b2 and b3 held constant, while width-defect designs may vary b2 and b3 with a2 and a3 held constant. The grating's periodicity may allow small placement errors of the diamond waveguide along the length of the grating during integration.

FIG. 3H depicts an air-mode configuration 370, representing a variation on the pitch-defect configuration. In configuration 370, the grating periodicity tapers from a larger pitch at the medial region to a smaller pitch toward the distal regions. The choice of taper function may affect how strongly the cavity mode is confined and thus the achievable quality factor. For example, parabolic and/or Gaussian tapers may provide high theoretical quality factors. Additionally or alternatively, one taper form may be selected over another based on fabrication considerations, such as the ability to reliably form the corresponding structures at the desired spatial resolution. The local defect admits a mode whose field distribution is confined within the diamond waveguide and the intervening air gaps between grating lines. Configuration 370 may thus reduce sensitivity to dielectric coupling (e.g., when coupling to the grating material is not desired).

FIG. 3I depicts an air-mode configuration 380, representing a variation on the width-defect configuration. In configuration 380, the diamond waveguide width tapers from a larger width at the medial region to a smaller width toward the distal regions while the grating mirrors remain periodic outside the defect. The choice of taper function may affect how strongly the cavity mode is confined and thus the achievable quality factor. For example, parabolic and/or Gaussian tapers may provide high theoretical quality factors. Additionally or alternatively, one taper form may be selected over another based on fabrication considerations, such as the ability to reliably form the corresponding structures at the desired spatial resolution. The resulting cavity mode may be confined within the diamond waveguide and air regions between the grating lines. Configuration 380 may be selected to reduce sensitivity to dielectric coupling while maintaining cavity confinement suitable for coupling to quantum emitters such as color centers or quantum dots.

As described above, the configurations of FIGS. 3E-3I may enable cavity resonance to be tuned by selecting values for a1-a5 and b1-b4. For visible-wavelength diamond color centers, exemplary photonic crystal cavities may employ silicon nitride gratings with central grating pitch a1 in the range of about 150-220 nm and diamond waveguide center widths b1 selected to place the cavity mode near an emitter zero-phonon line. In some implementations, coarse tuning may be achieved by choosing among diamond waveguides of different widths, while fine tuning may be performed by integrated piezoelectric actuators as described elsewhere herein.

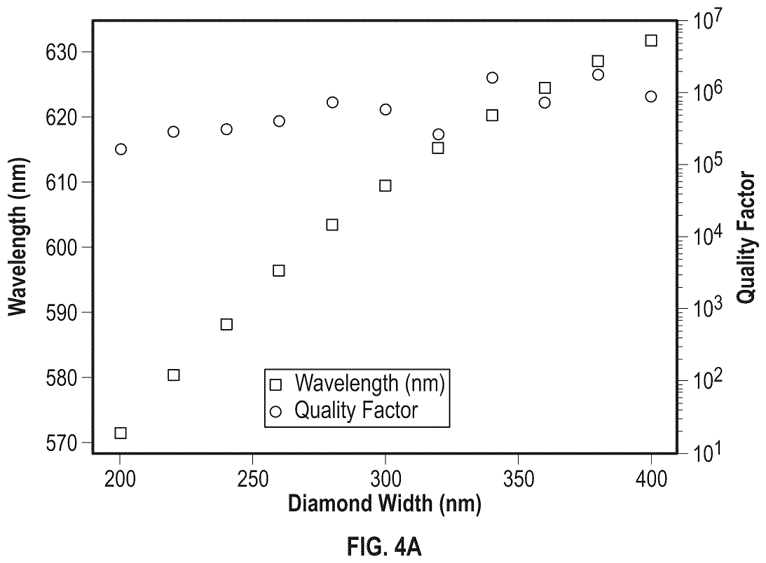

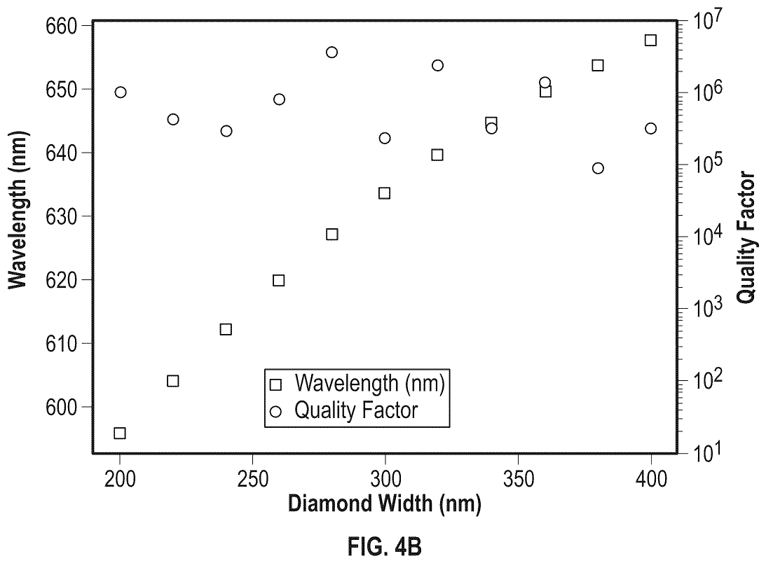

FIGS. 4A-4B show data relating the medial width of a nanobeam of example hybrid photonic crystal cavities to the quality factor of the crystal cavities, according to some embodiments. The quality factor of a crystal cavity is a measure of how well light is confined within the cavity and how much energy is lost per optical cycle. Higher quality factor means energy is more slowly dissipated out of the cavity. A higher quality factor means a longer time for interaction between the desired quantum emitter and the cavity mode. A higher quality factor will generally lead to a larger enhancement of the spectral signal from the quantum emitter at the desired frequency. The example PhC cavities comprised diamond nanobeams with different medial widths (ranging from about 200 nm to about 400 nm) and silicon nitride gratings. The data shown in FIG. 4A was collected for a PhC cavities having a grating pitch of 170 nm. The data shown in FIG. 4B was collected for a PhC cavities having a grating pitch of 180 nm, an adiabatic taper length of 10 μm with 20 pitches in the taper, a grating thickness of 150 nm, a grating duty cycle of 50%, and a nanobeam thickness of 100 nm. As indicated in both FIG. 4A and FIG. 4B, changing the medial width of the nanobeam can adjust the cavity mode (wavelength) by tens of nanometers. The quality factor of the PhC cavities remains high (e.g., >10⁵) as the geometry of the nanobeam is adjusted.

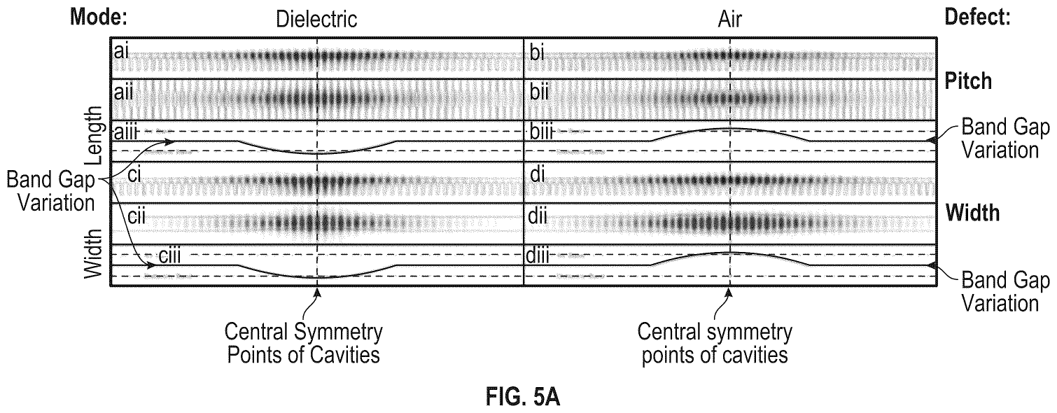

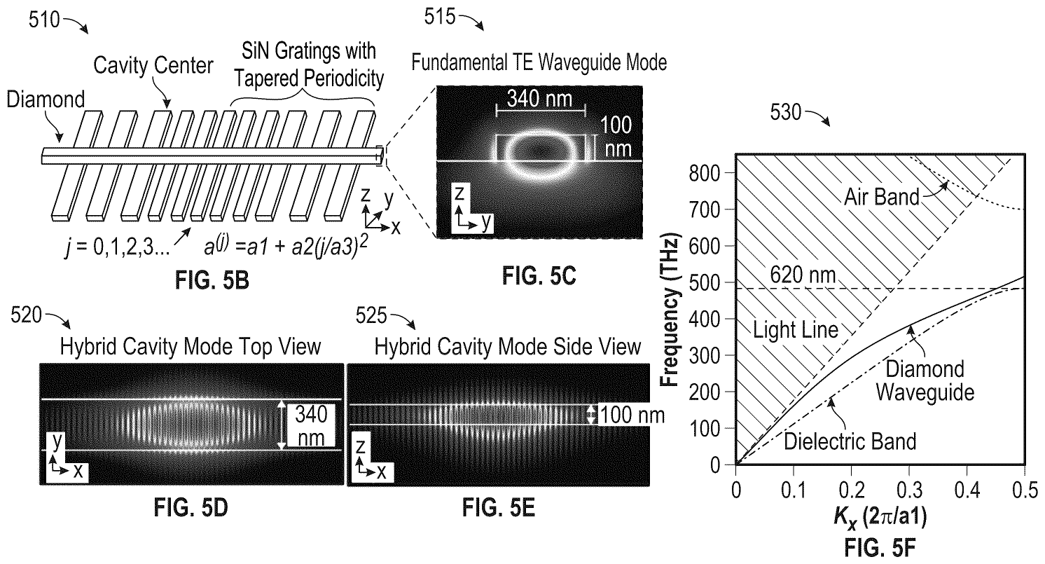

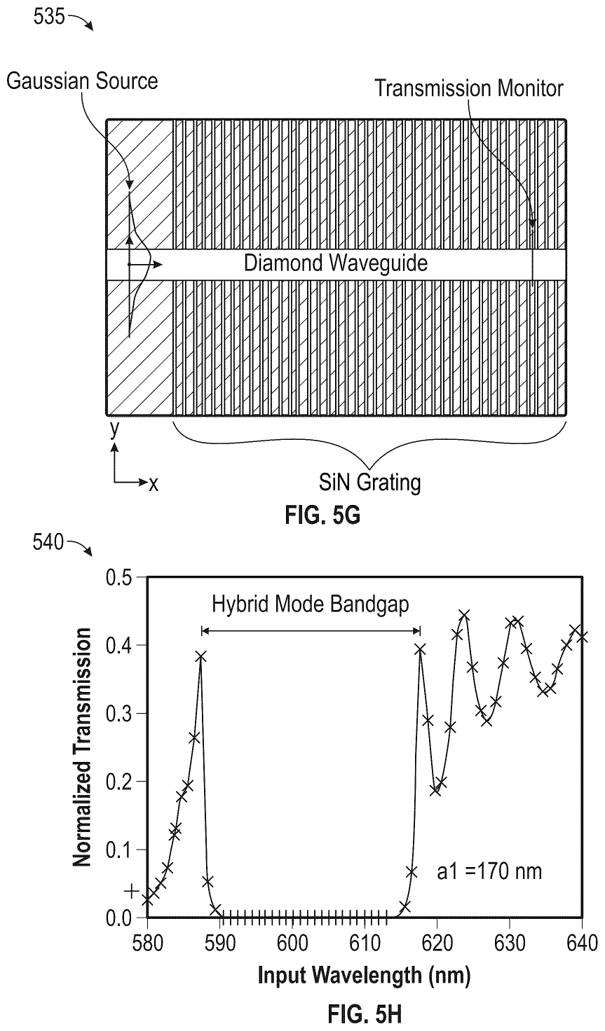

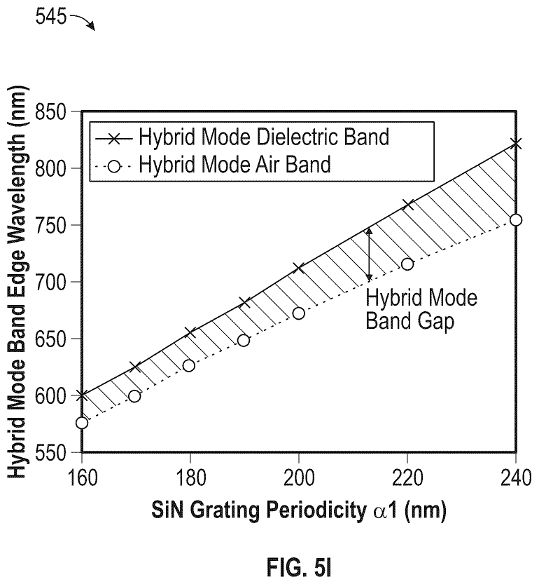

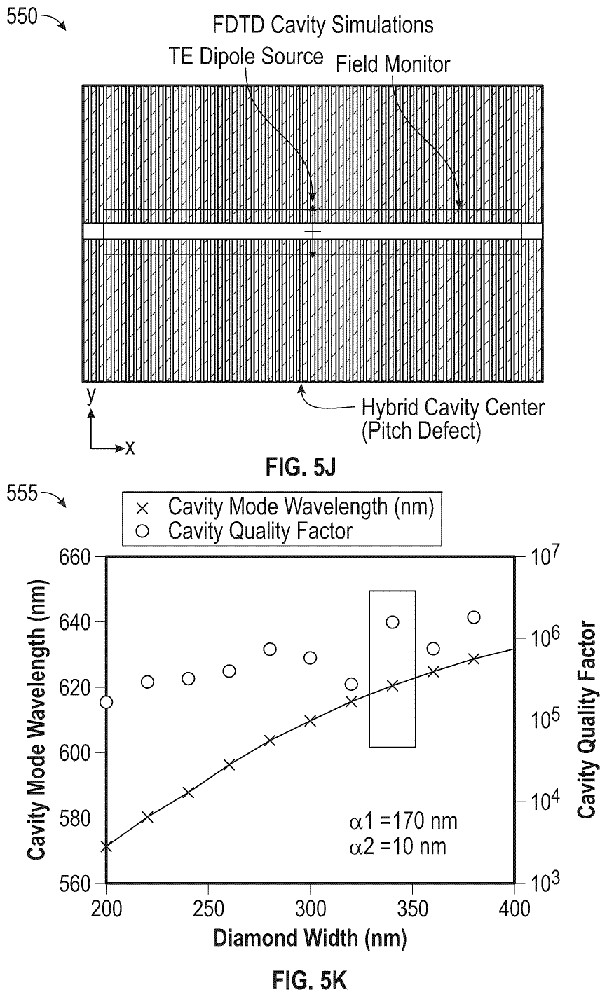

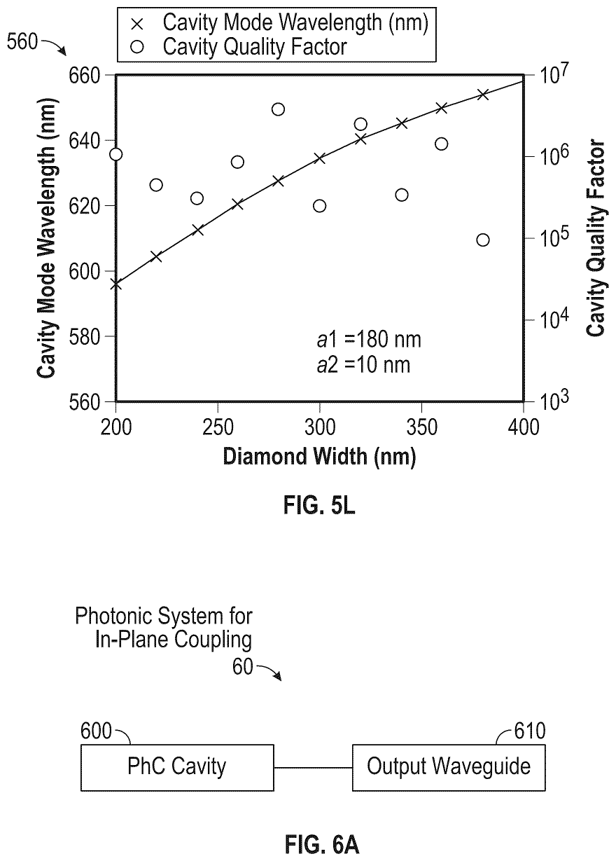

FIG. 5A shows example electric field mode profiles for dielectric mode hybrid PhC cavities and air mode hybrid PhC cavities. The vertical dotted lines indicate the central symmetry points of the cavities. The solid line indicates the variation in the band gap that generates the cavity mode. The horizontal dotted lines indicate the dielectric and air band edges for the bandgap of the distal region. The solid line indicates variation in the dielectric or air band edge of the central region that generates the cavity mode.

FIGS. 5B-5L depict simulation results for a pitch-defect hybrid cavity, including a schematic of the cavity geometry, numerical field distributions of the supported optical modes, corresponding band diagrams of the component structures, and plots of cavity resonance characteristics as geometric parameters are varied. FIG. 5B depicts a pitch-defect hybrid cavity configuration 510. A diamond nanobeam is disposed on top of a silicon nitride grating formed from silicon nitride. The grating lines taper parabolically in periodicity from a smaller pitch at the medial region of the cavity to a larger pitch at the distal mirror regions. The variation in pitch can be expressed as a parabolic function of position: a^{(j)}=a1+a2 (j/a3)², in which a^{(j)} is the grating pitch at the j-th period away from the cavity center (e.g., j is an integer from 0 to a3), a1 is the central grating pitch, a2 is the change in grating pitch from center to mirror over taper region, and a3 is the number of periods in grating taper. Outside of the medial region of the cavity, the remaining grating lines form mirror regions with pitch equal to a1+a2. This parabolic pitch variation locally admits a defect state within the photonic bandgap of the grating, thereby supporting a confined cavity mode.

In addition to the parabolic taper described above, other taper functions may be employed to form the pitch-defect region of the hybrid cavity. For example, a Gaussian taper may be defined by the function a^{(j)}=a−(a−a1) exp(−j²/(2σ²)), where j is an integer from 0 to infinity for one side of the cavity and the taper is symmetric about the center of the cavity. In this relation, a1 corresponds to the central pitch, while a=a1+a2 represents the mirror pitch, with a1 and a2 defined as above for the parabolic taper function. Although the Gaussian taper may be an infinite taper, in practice the grating pitch approaches a repeating mirror pitch of approximately a (as indicated in the above function) after a certain number of periods from the center of the grating. Said certain number of periods may be a function of the value of σ. The σ parameter may thus behave similarly to a3 in the parabolic taper expression, in which larger values of σ correspond to a longer taper from the center pitch to the mirror pitch. The Gaussian taper may be effective in monolithic photonic crystal cavities and in the hybrid photonic crystal cavity geometry disclosed herein. For example, the Gaussian taper may be used in addition or as an alternative to the parabolic taper. Additionally or alternatively, a linear taper may be used, with the linear taper defined by a^{(j)}=a1+a2 (j/a3).

FIG. 5C depicts a numerical calculation 515 of the fundamental transverse electric (TE) hybrid optical mode supported by pitch-defect hybrid cavity configuration 510 of FIG. 5B. The simulation shows that the mode is jointly confined within the diamond nanobeam and the underlying silicon nitride grating, consistent with a dielectric-mode configuration.

FIGS. 5D and 5E show numerical calculations 520 and 525 of the same hybrid cavity mode viewed from the top and side, respectively. These field distributions highlight confinement within the central defect region defined by the parabolic pitch taper and illustrate the overlap of the optical mode with both the diamond nanobeam and the silicon nitride grating. The confinement is strongest at the cavity center and decays into the surrounding mirror regions.

FIG. 5F depicts plot 530 including individual band diagrams (frequency as a function of normalized wavevector) for the periodic silicon nitride grating and the diamond nanobeam waveguide, calculated at a central grating pitch a1 of 170 nm, grating fill factor a5 of 0.5, waveguide center width b1 of 340 nm, and waveguide height b4 of 100 nm. The dielectric and air bands of the grating structure are shown along with the dispersion relation of the diamond nanobeam waveguide, demonstrating the bandgap region in which the hybrid cavity mode resides. The band diagram confirms that the hybrid mode may be formed through coupling between the diamond nanobeam waveguide and the silicon nitride grating structure.

FIGS. 5G-5I depict simulations of the hybrid optical mode bandgap, including the propagation setup, transmission spectrum, and extracted band edges for diamond nanobeam-silicon nitride grating cavity geometries. FIG. 5G depicts a schematic diagram 535 of Gaussian beam propagation simulations for the full three-dimensional hybrid geometry. In this example, the silicon nitride grating periodicity is varied while the diamond nanobeam is held at a width b1 of 340 nm and a height b4 of 100 nm.

FIG. 5H depicts a normalized transmission plot 540 for hybrid diamond nanobeam-silicon nitride grating propagation at a central grating pitch a1 of 170 nm. The transmission spectrum shows the photonic bandgap as a function of input wavelength. The bandgap accounts for contributions from the periodic silicon nitride grating structure, diamond nanobeam waveguide dispersion, and the evanescent coupling between the two materials.

FIG. 5I depicts a plot 545 of wavelength band edges extracted from additional propagation simulations. The hybrid mode band edge wavelengths of the dielectric and air bands of the silicon nitride grating are plotted for multiple silicon nitride grating periodicities. These results demonstrate the hybridization of the optical modes and confirm the range of frequencies where the photonic bandgap prevents transmission.

FIGS. 5J-5L depict simulations of cavity resonance wavelength and quality factor as functions of diamond nanobeam width for pitch-defect designs. FIG. 5J depicts a schematic diagram of the hybrid cavity simulation used to evaluate cavity mode dependence on diamond nanobeam waveguide width. A transverse electric (TE) point dipole source excited the cavity, and surrounding electric-field monitors were used to record temporal field decay to determine resonance frequency and quality factor.

Similar to FIGS. 4A and 4B, FIGS. 5K and 5L depict simulated cavity resonance wavelength and quality factor, respectively, as functions of diamond nanobeam width for two exemplary pitch-defect hybrid cavity designs. In FIGS. 5K and 5L, the cavity mode wavelength and simulated quality factor are plotted as functions of diamond nanobeam width for two exemplary pitch-defect designs with a central grating pitch a1 of 170 nm (FIGS. 5K) and 180 nm (FIG. 5L). Other parameters include change in grating pitch from center to mirror over taper region a2 of 10 nm, number of periods in grating taper a3 of 20 periods, silicon nitride thickness a4 of 150 nm, grating fill factor a5 of 0.5, and diamond waveguide height b4 of 100 nm. The box annotation in FIG. 5K indicates a cavity mode wavelength, cavity quality factor, and diamond nanobeam width used for one or more simulations including, for example, those shown in FIGS. 5B-5I, 7B-7D, 10D-10F, and 11B. FIGS. 5K and 5L show that the cavity resonance can be tuned over tens of nanometers by selecting among diamond waveguides of different widths, while maintaining quality factors in excess of 10⁵ and without fabricating a new silicon nitride grating. In this way, coarse tuning of the hybrid cavity can be achieved through the choice of diamond waveguide dimensions, while finer tuning can be achieved using integrated piezoelectric actuators as described elsewhere herein.

In evaluating photonic crystal cavities, three representative Q-optimized hybrid cavity geometries were analyzed. The following text describes the geometric parameters and resulting cavity properties for each geometry. For each geometry, the diamond waveguide center width (b1) ranged from 310 nm to 400 nm, while the change in diamond waveguide width from center to mirror (b2) was set to 0 and the diamond waveguide taper length (b3) was likewise set to 0, indicating no width-defect taper was introduced. The diamond waveguide height (b4) was 100 nm for all three geometries. The central grating pitch (a1) was either 170 nm or 180 nm, and the change in grating pitch from the center to the mirror region (a2) was 10 nm. The number of periods in the grating taper (a3) was 20, and the silicon nitride thickness (a4) was 150 nm. The grating fill factor (a5) was held constant at 0.5 across all geometries.

The resulting cavity modes occurred at 636.5 nm, 657.7 nm, and 619.5 nm for the three geometries. The simulated unloaded quality factor (Q) values were 5.77×10⁷, 1.50×10⁶, and 3.95×10⁵. The extracted optical mode volumes (V) were 4.54×10⁻²⁰ m³, 5.31×10⁻²⁰ m³, and 4.50×10⁻²⁰ m³. The effective refractive indices (n_{eff}) were 1.81, 1.85, and 1.852, yielding normalized mode volumes (Vₙₒᵣₘ) of 1.04, 1.19, and 1.20 (λ/n_{eff})³. The calculated mode volumes are only slightly larger than those of monolithic diamond nanobeam photonic crystal cavities, while the hybrid geometry may provide a more repeatable and flexible construction platform that supports operation at either nitrogen vacancy (NV) or tin vacancy (SnV) color center wavelengths.

The above three cases represent exemplary simulated geometries chosen to demonstrate cavity performance near the desired emission wavelengths for color center emitters of interest. The parameter ranges disclosed are not limiting, and the geometric values may be adjusted across broader ranges to achieve a target cavity wavelength. For example, the selection of cavity geometry may be based on the wavelength at which the cavity mode is intended to occur. By varying the width of the diamond waveguide and/or the center pitch of the grating, the resonance wavelength can be shifted to different values, while maintaining confinement and/or high quality factor operation. Similarly, variations in the diamond waveguide thickness may be employed to tune the resonance.

For example, the diamond waveguide center width may, in some implementations, range from about 200 nm to about 600 nm. At larger or smaller dimensions, fabrication limitations may influence the achievable feature resolution, as smaller structures or finer geometric variations may be more challenging to generate using lithographic techniques. Moreover, design considerations may constrain the maximum thickness of the diamond waveguide, particularly in implementations in which light is directed preferentially into one side of the diamond waveguide and subsequently transferred into an underlying silicon nitride waveguide of a photonic integrated circuit. In such implementations, an excessively thick diamond waveguide may reduce efficient coupling, and geometry may thus be chosen to balance cavity performance with fabrication feasibility and/or integration considerations.

Additional simulations further illustrate the flexibility of the hybrid cavity geometry. As shown in FIG. 3C, when the diamond waveguide width is fixed at about 340 nm, sweeping the central grating pitch from about 160 nm to about 240 nm may tune the dielectric cavity resonance wavelength from about 575 nm to greater than about 800 nm. Similarly, FIG. 4 shows that when the central pitch is held constant at selected values, varying the diamond waveguide width between about 200 nm and about 400 nm may shift the dielectric cavity resonance wavelength by at least about 50 nm. This tunability may provide practical design flexibility, as pre-fabricated silicon nitride gratings may be combined with an array of diamond waveguides of different geometries. By selecting an appropriate diamond waveguide from such an array and stamping it onto a prepared grating, cavity modes at desired wavelengths may be achieved with lower fabrication overhead.

### Coupling Configurations

A hybrid PhC cavity such as cavities 100-300 shown in FIGS. 1-3 can be configured for efficient in-plane and out-of-plane optical coupling, enabling the cavity to be integrated into larger opto-electronic or photonic systems.

### In-Plane Coupling

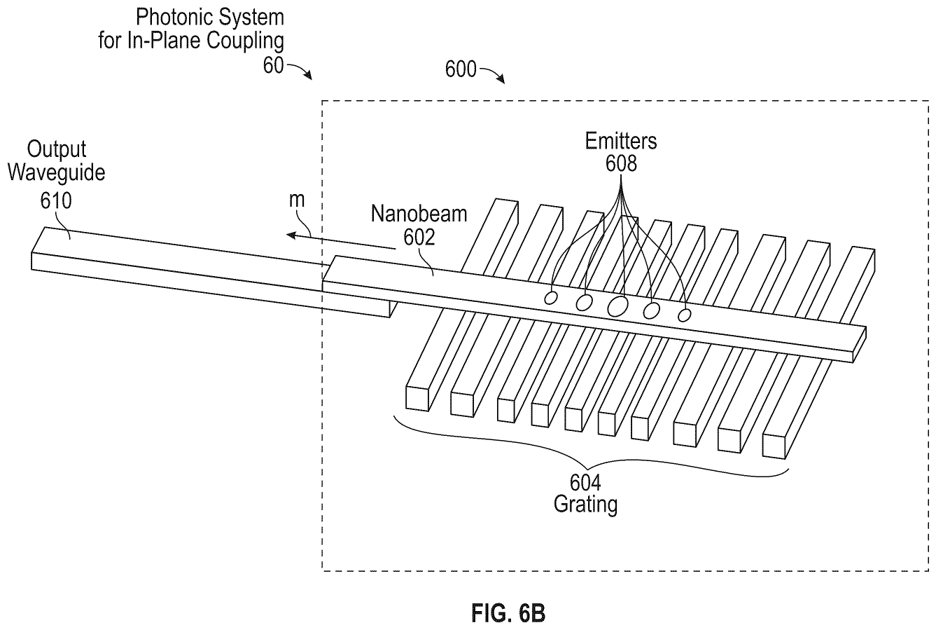

FIGS. 6A and 6B, respectively, show a block diagram and an example of a photonic system 60 for facilitating in-plane optical coupling from the nanobeam (labeled 602 in FIG. 6B) of a hybrid PhC cavity 600. An output waveguide 610 can be optically coupled to receive light from a distal end of a nanobeam 602 of a hybrid PhC cavity 600. A distal end of a waveguide 610 can be positioned adjacent to or can overlap with a distal end of the nanobeam. Waveguide 610 can, e.g., be etched into the same substrate upon which the grating 604 of PhC cavity 600 is disposed, that is, waveguide 610 and PhC cavity 600 can be components of the same wafer/photonic integrated circuit. In other embodiments, waveguide 610 can be a component of a different wafer/photonic integrated circuit. Light emitted by emitters 608 in nanobeam 602 can be output through the distal end of nanobeam 602 and coupled into waveguide 610, as indicated by arrow m in FIG. 6B.

System 60 can be used for any application in which light from PhC cavity 600 needs to be transmitted from PhC cavity 600 to another optical component that is positioned in (approximately) the same plane as cavity 600. For example, system 60 can be used to facilitate the transmission of light from PhC cavity 600 to an optical component (e.g., a sensor or another PhC cavity) on the same chip as PhC cavity 600. In some embodiments, in-plane coupling allows for on-chip readout of cavity coupled quantum emitter light that can be routed on the PIC to other components needed to perform quantum computing, such as Mach-Zender Interferometer meshes to generate entanglement between photons emitted from different cavity coupled emitters. This can be further routed to on-chip detectors such as superconducting single photon detectors (SNSPDs). In-plane coupling can simplify the quantum computer design effort by isolating all the components needed for the computation onto a single PIC.

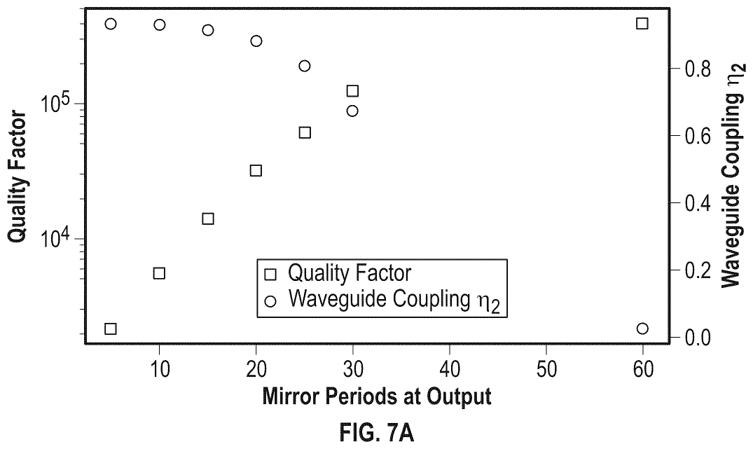

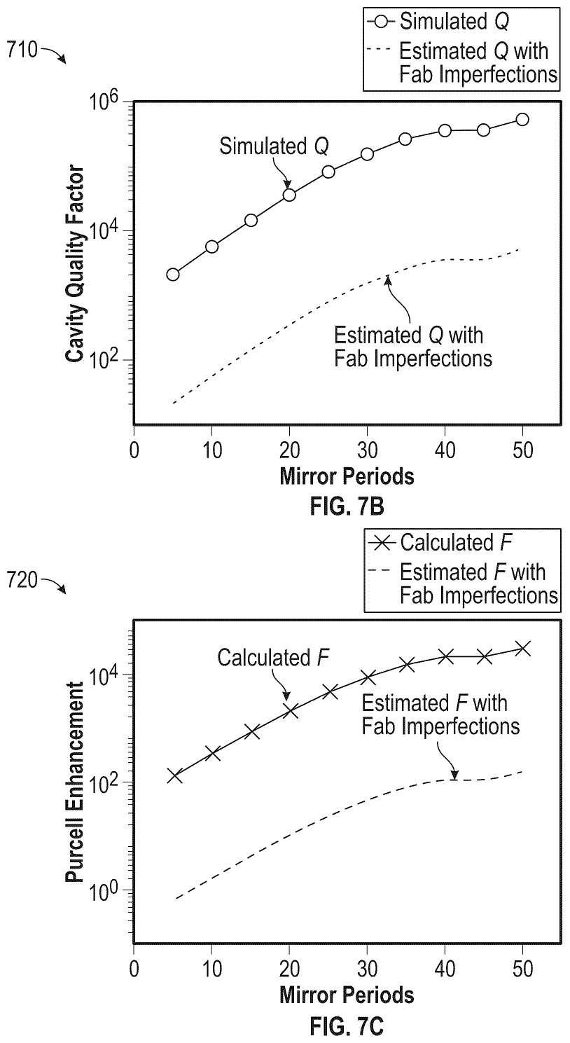

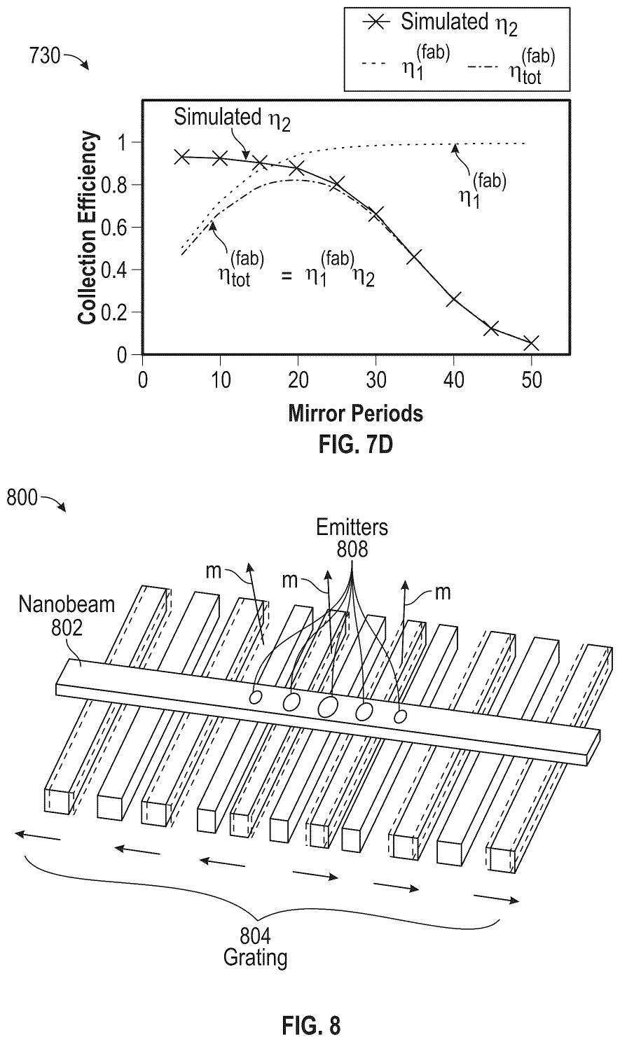

Example data relating the number of mirror periods (where mirror periods may refer to periods in the distal region after the adiabatic tapering from the center is completed, e.g. the number of repeating pitches at 180 nm if the center pitch was 170 nm and it took 20 pitches to taper out from 170 to 180 nm) on the side of a hybrid PhC cavity that is configured to output light out of one end of the nanobeam to an output waveguide to the quality factor of the PhC cavity and the percent light coupling out to the waveguide is shown in FIG. 7A. The PhC cavity in this example has a grating pitch of 170 nm, an adiabatic taper length of 10 μm with 20 pitches in the taper, a grating thickness of 150 nm, a grating duty cycle of 50%, a nanobeam medial width of 340 nm, and a nanobeam thickness of 100 nm. The cavity mode is 619.6 nm. As shown, the quality factor of the PhC cavity may be higher (e.g., >10⁵) when the amount of light that is coupled into the output waveguide is lower (e.g., >0.2), and the quality factor of the PhC cavity may be lower (e.g., <10⁵) when the amount of light that is coupled into the output waveguide is higher (e.g., >0.6).

FIG. 7B depicts a plot 710 of the simulated cavity quality factor (Q) as the number of mirror periods on the photon collection side is varied for a dielectric pitch-defect cavity mode at 619.5 nm. The geometric parameters include central grating pitch a1 of 170 nm, change in grating pitch from the center to the mirror region a2 of 10 nm, number of periods in the grating taper a3 of 20, silicon nitride thickness a4 of 150 nm, and grating fill factor a5 of 0.5, with diamond waveguide center width b1 of 340 nm and diamond waveguide height b4 of 100 nm. As shown in plot 710, increasing the number of mirror periods increased the quality factor. Plot 710 further includes estimated lower Q values to account for fabrication imperfections such as sidewall roughness or material absorption.

FIG. 7C depicts a plot 720 of the corresponding Purcell factor (F) calculated from the simulated quality factor of plot 710. The Purcell factor increases with higher Q values, reflecting stronger light-matter interaction within the cavity. An estimated lower Purcell factor, derived from the reduced Q due to fabrication imperfections, is also shown in plot 720.

Similar to FIG. 7A, FIG. 7D depicts a plot 730 of the simulated coupling efficiencies η₁, η₂, and ηₜₒₜ. Here, η₁^{(fab)} represents the spectral efficiency reduced by fabrication-imperfect Q, η₂ is the collection efficiency into the desired waveguide mode, and ηₜₒₜ^{(fab)} is the resulting total efficiency. Plots 710, 720, and 730 thus indicate that there may be an optimal number of mirror periods that balance high collection efficiency via the waveguide with maintenance of a sufficiently high Purcell factor of the cavity.

### Out-of-Plane Coupling

FIG. 8 shows an example hybrid PhC cavity 800 that is configured for out-of-plane coupling. The adiabatic tapering of the pitch is modulated with an adjustment (or perturbation) of the thickness of each beam of the grating in order to adjust the direction of output of light from the cavity and optimize it vertically upward. In addition to the adiabatic tapering of pitch, the width of each beam in the grating from the center alternates getting slowly thicker and thinner through the adiabatic taper region. The rate at which the line widths change is variable and may depend on the other geometric parameters to create optimal vertical output. This may be referred to as a “grating” perturbation because it causes an effect similar to a grating coupler, which is a periodic nanostructure designed to route light on and off photonic integrated chips.

In some embodiments, PhC cavity 800 comprises a metal backplane to minimize loss of emitter light into underlying substrate. In some embodiments, the grating is placed on the metal backplane with an optimized thickness of silicon dioxide between the metal backplane and where the grating pattern starts. Such a metal backplane can be deposited as a layer within the larger PIC stack as well for larger scale PIC integration.

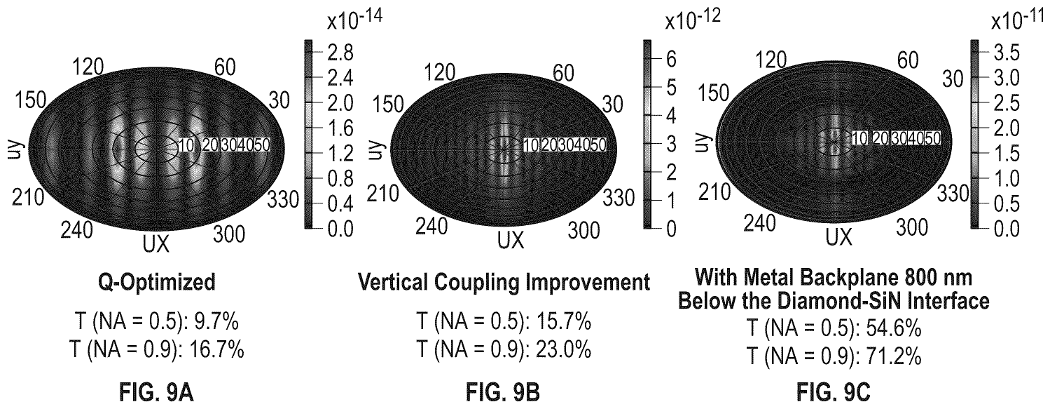

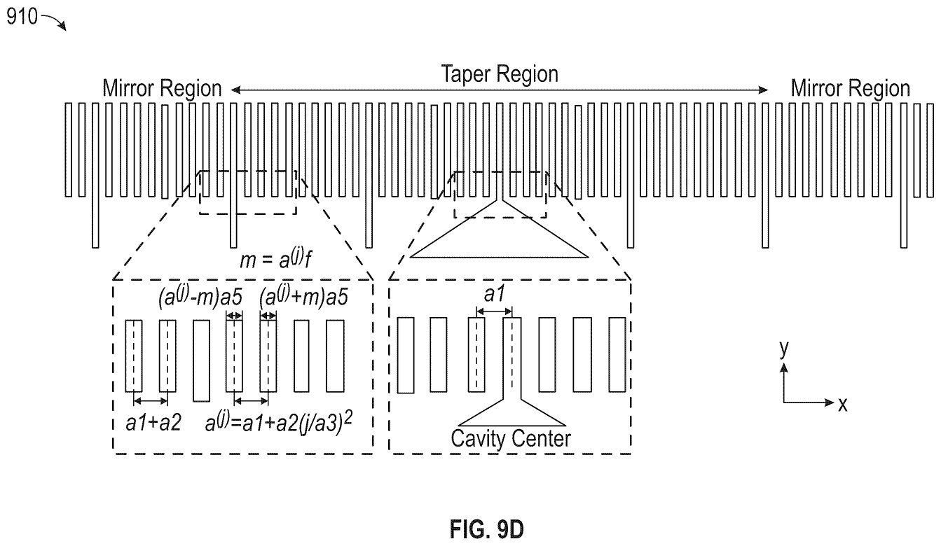

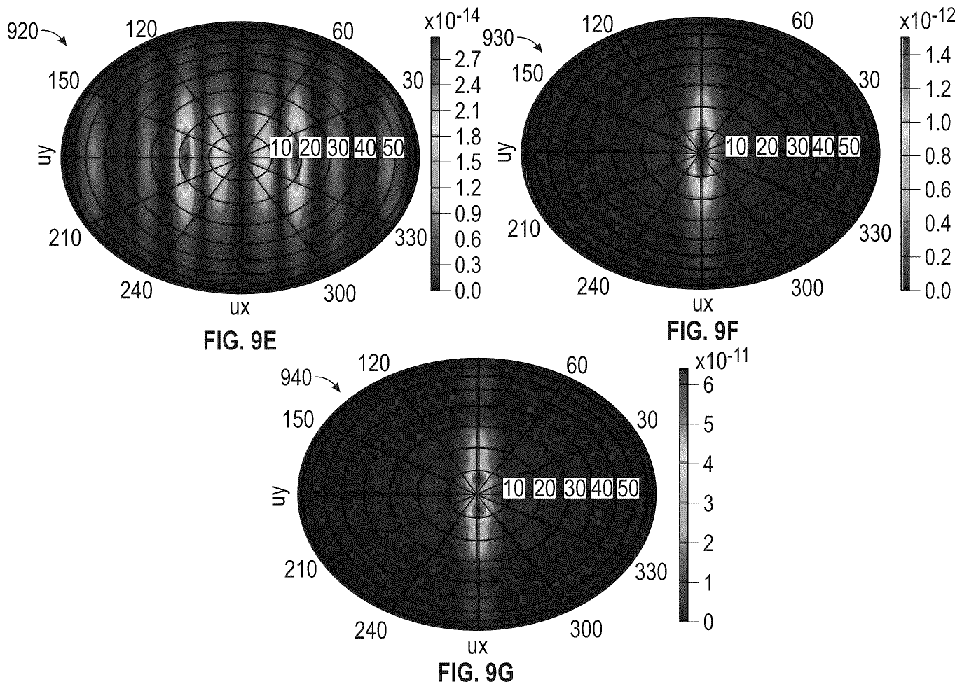

FIGS. 9A-9C show example far-field projections of the squared magnitude of the electromagnetic field from an emitter in hybrid PhC cavities configured for out-of-plane coupling. The PhC cavities used in these examples included diamond nanobeams comprising a plurality of color centers and silicon nitride gratings. The data in FIG. 9A is for a PhC cavity optimized for quality factor. The data in FIG. 9B is for a PhC cavity comprising a grating perturbation applied on top of an adiabatic grating taper (e.g., as illustrated in FIG. 8). The data in FIG. 9C is for a PhC cavity comprising a metal backplane to minimize loss of emitter light into the underlying substrate of the cavity. In FIGS. 9A-9C, T refers to the fraction of total light emitted out of the cavity that is transmitted vertically upward within a region that would be collected by a microscope objective with the given numerical aperture=NA.

FIG. 9D depicts a schematic 910 of a pitch-defect hybrid cavity configured for vertical out-coupling of light. The hybrid cavity includes a diamond nanobeam waveguide disposed on a patterned silicon nitride grating with quadratic tapering from the center of the cavity. The central region of the cavity may be defined by a central grating pitch a1, while mirror regions extend outward on each side with pitch values approaching a1+a2. Between the central region and the mirror regions lies a grating taper region of length a3 periods, in which the grating pitch varies quadratically according to the relation a^{(j)}=a1+a2 (j/a3)², where j is the period index measured from the cavity center. The design parameters include a central grating pitch a1 of 170 nm, a change in grating pitch from center to mirror over taper region a2 of 10 nm across a grating taper length a3 of 20 periods, a silicon nitride thickness a4 of 150 nm, and a grating fill factor a5 of 50%. The diamond nanobeam has a center width b1 of 340 nm, a change in diamond nanobeam width from center to mirror over taper region b2 of 0, a diamond nanobeam taper length b3 of 0, and a diamond nanobeam height b4 of 100 nm.

A perturbation factor f may also be applied to the grating lines, such that a modulation width m=a^{(j)}f may alter the effective line width from (a^{(j)}−m)a5 to (a^{(j)}+m)a5, thereby enhancing vertical scattering. For example, a perturbation factor f of 0.02 may be applied to the grating lines to promote upward emission. Perturbation may refer to a small deformation or adjustment of existing cavity parameters (e.g., geometry, refractive index distribution, and/or boundary conditions) that slightly modifies the electromagnetic field distribution or resonant frequencies. In some configurations, the perturbation may involve modifying the geometry of the grating lines (e.g., the thickness of the grating lines) to change the output direction of light from the cavity mode. While analytical treatments of perturbations are possible in simplified systems, for some complex hybrid cavity geometries, numerical simulations provide a more practical method of evaluating cavity effects. Moreover, perturbations are not limited to line thickness modulation. Other types of geometric modifications, such as adding surface features and/or bumps of varying size to the exterior of the diamond waveguide, may produce similar effects on vertical scattering. For example, grating line perturbation may form cavity mode confinement near about 619.5 nm while enabling efficient free-space collection.

FIGS. 9E-9G depict far-field profiles of the squared electric field magnitude for the hybrid cavity of schematic 910 depicted in FIG. 9D. The far-field profiles of FIGS. 9E-9G correspond to different vertical out-coupling configurations. In this context, transmission efficiency T(NA) refers to the fraction of optical power emitted by the cavity that is collected within a numerical aperture NA of a corresponding collection optic, such as an objective lens. FIG. 9E depicts profile 920 corresponding to a Q-optimized cavity structure, with transmission efficiencies T(NA=0.5) of 11.1% and T(NA=0.9) of 19.1%. FIG. 9F depicts profile 930 corresponding to the same Q-optimized cavity structure as profile 920 and with grating line perturbation applied, which increases vertical propagation and narrows the emission cone, resulting in transmission efficiencies T(NA=0.5) of 25.6% and T(NA=0.9) of 31.5%. FIG. 9G depicts profile 940 corresponding to the same Q-optimized cavity structure as profiles 920 and 930, with the addition of a backplane (e.g., a metal backplane) positioned approximately 700 nm below the bottom of the silicon nitride grating lines. Said backplane may further direct emission vertically upward, achieving transmission efficiencies T(NA=0.5) of 72.9% and T(NA=0.9) of 86.9%.

The transmission efficiencies depicted in FIGS. 9E-9G demonstrate how successive structural modifications may be applied to direct a larger fraction of the cavity emission vertically upward for free-space collection, such as by a microscope objective. In the Q-optimized cavity configuration of FIG. 9E, only a relatively small fraction of the optical power may be transmitted upward, which may limit performance in applications such as quantum entanglement in which efficient photon collection at the emitter wavelength is desired. Applying grating line perturbation, as in FIG. 9F, may reshape the upward emission pattern of the cavity mode, narrowing the cone of emission and centralizing the far-field profile, thereby improving coupling into the numerical aperture of a collection optic. However, a significant portion of the emission may be directed downward into the substrate. The addition of a metal backplane, as shown in FIG. 9G, may produce constructive and/or destructive interference that redirects a significant portion of the emission vertically upward, substantially increasing the fraction of light emitted within the collection angle of an objective lens. The design goal in such configurations may be to maintain a relatively high cavity quality factor to improve emission at the desired wavelength, while ensuring that a significant fraction of the total emitted light may be collected in the vertical direction. Additional modifications, analogous to optimization strategies used for waveguide-coupled diamond nanobeam cavities, may be pursued to further optimize quality factor and/or collection efficiency.

### Piezoelectric Tuning of Cavity Mode and Nanobeam Emitters

A hybrid PhC cavity, particularly a cavity comprising quantum emitters such as color centers or quantum dots, can have large variations in cavity resonance and emitter frequencies due to uncontrolled imperfections that arise during fabrication. If a system includes multiple hybrid PhC cavities, discrepancies in the emitter frequencies between the cavities can inhibit scaling-up of the system. Independently targeting and tuning the cavity mode and the emitter mode can enable different emitter frequencies in different cavities to be matched a single frequency, thereby facilitating, e.g., scalable on-chip entanglement protocols.

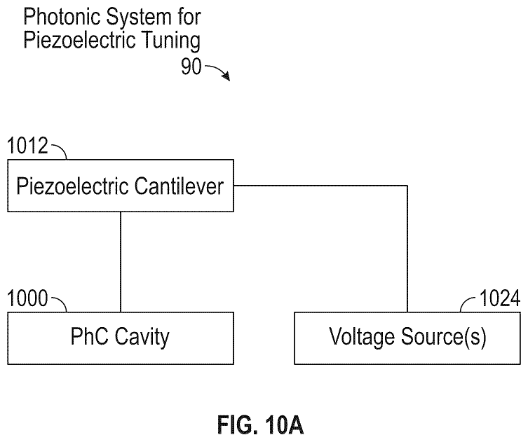

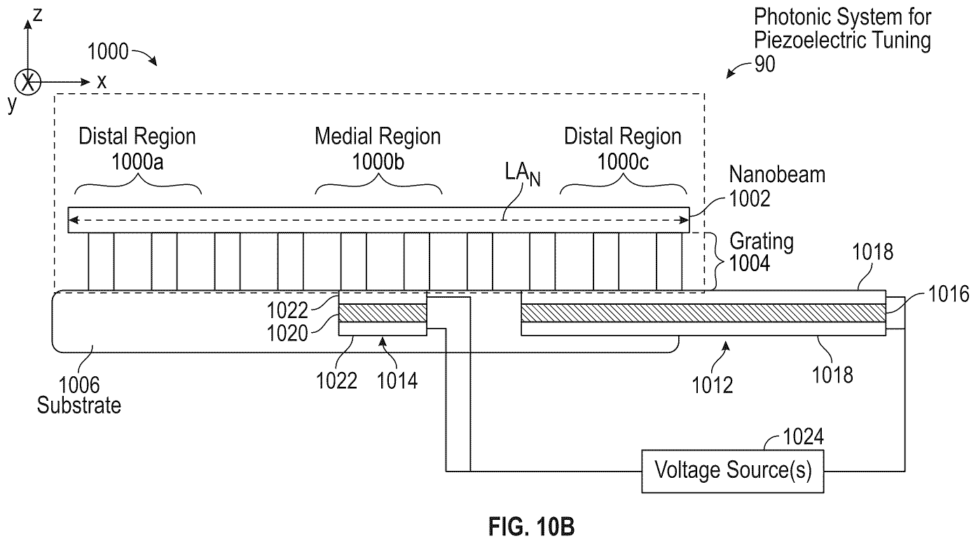

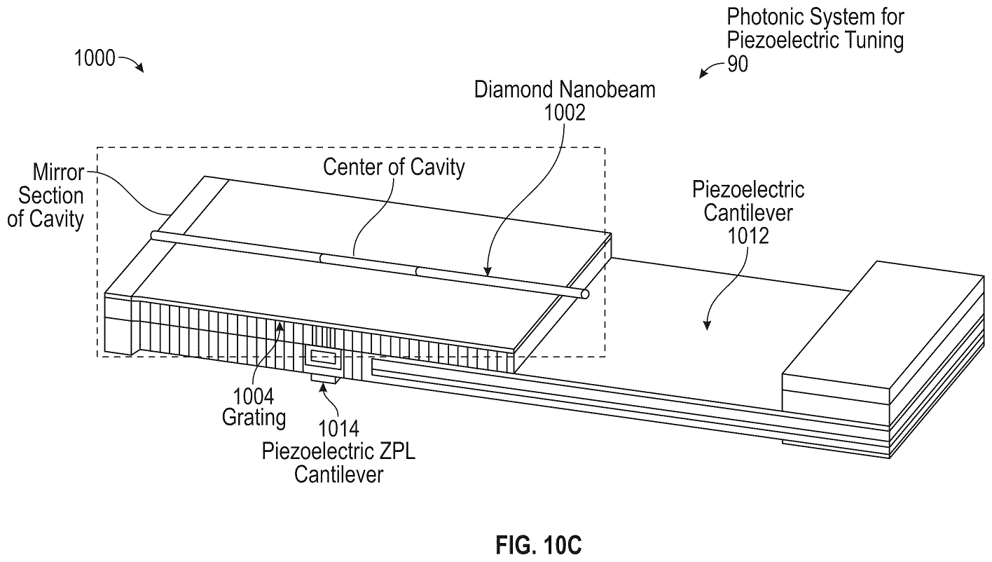

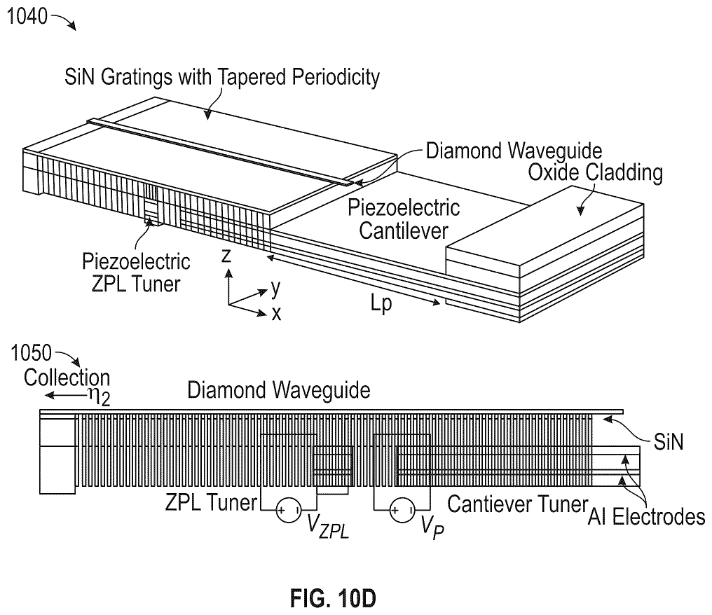

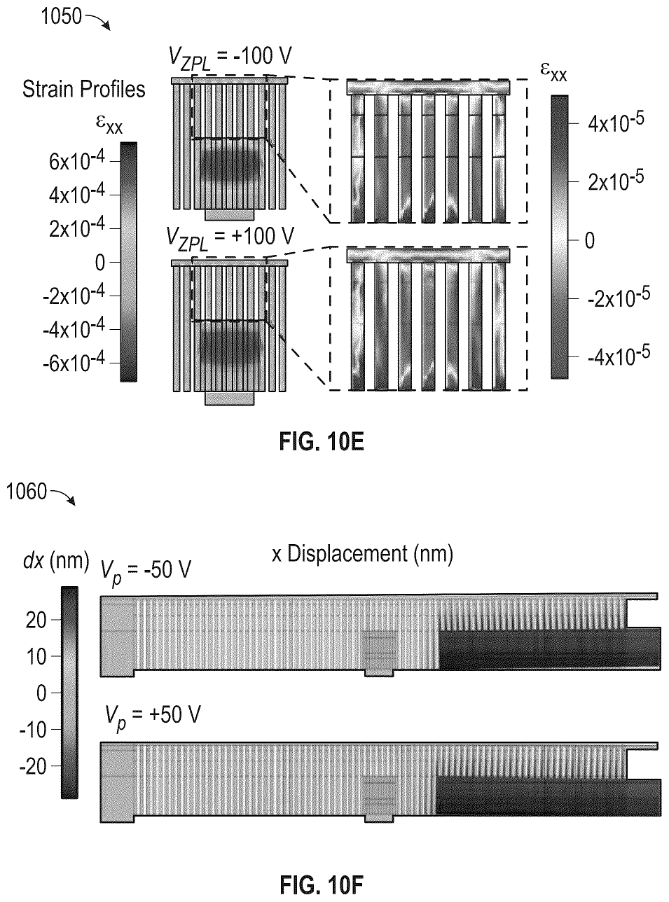

In some embodiments, the modes of a hybrid PhC cavity are tuned piezoelectrically. FIG. 10A shows a block diagram of a system 90 for piezoelectrically tuning the modes of a hybrid PhC cavity 1000. A piezoelectric cantilever 1012 can be formed from a beam or a sheet of piezoelectric material and can be attached to at least a portion of cavity 1000. For example, cantilever 1012 can be attached to a distal region of cavity 1000. Cantilever 1012 can be electrically coupled to a voltage source 1024. Voltage that is applied to cantilever 1012 can induce mechanical deformations in the piezoelectric material of cantilever 1012 that, in turn, induces strain in the grating of cavity 1000. This strain can cause changes in the modes of cavity 1000. Controlling the voltage applied to cantilever 1012 by voltage source 1024 therefore enables the modes of cavity 1000 to be tuned.

FIG. 10B shows a side view of an exemplary implementation of system 90. A first distal region 1000a of cavity 1000 can be affixed to a substrate 1006. The other distal region 1000c of cavity 1000 can be attached to a piezoelectric cantilever 1012. Piezoelectric cantilever 1012 can comprise a piezoelectric material 1016 (e.g., aluminum nitride) sandwiched between layers of electrode material 1018 (e.g., aluminum). Electrode layers 1018 can be electrically coupled to a voltage source 1024. Applying a voltage to electrode layers 1018 can cause piezoelectric layer 1012 to mechanically deform, thereby inducing strain in the grating 1004 and the nanobeam 1002 of PhC cavity 1000.

In some embodiments, an additional piezoelectric cantilever 1014 underlies a medial region 1000b of PhC cavity 1000. Like cantilever 1012, cantilever 1014 can include a layer of a piezoelectric material 1020 sandwiched between layers of electrode material 1022. Electrode layers 1022 can be electrically coupled to a voltage source 1024. Applying a voltage to electrode layers 1022 can cause piezoelectric layer 1020 to mechanically deform and can generate strain in the medial region 1000b of PhC cavity 1000. If nanobeam 1002 includes emitters (e.g., color center emitters), cantilever 1014 can be used to target and tune the emitter frequencies. For example, cantilever 1014 can be used to tune the zero phonon line (“ZPL”) emission frequency of a color center emitter.

FIG. 10C shows an example implementation of PhC cavity 1000. In this implementation, PhC cavity 1000 includes a diamond nanobeam that includes a color center emitter (not shown). Cavity 1000 has a cavity geometry for a cavity mode around 619 nm, with 20 pitches from the center of the cavity to the mirror section and 20 mirror periods on each side. Each side may refer to half the crystal cavity, and 20 mirror periods on each side may mean that on each side, after the taper region, there are 20 lines repeating of the given pitch in the distal region. The mirror section may refer to the region after the tapering from the center is completed, for example as shown at the distal region in the diagram in FIG. 10C. In this example with 20 pitches and 20 mirror periods on each side, there are 20 beams in the grating between the center and the start of the mirror region, that taper from about 170 nm pitch gradually to about 180 nm pitch at the start of the mirror/distal region. The mirror sections may be etched through and connected only at the ends in a snake-like pattern, thereby reducing the overall mechanical rigidity of the cavity region. One side of the cavity is clamped while the other side is attached to piezoelectric cantilever 1012. In some embodiments, one side of the cavity is attached to the cantilever, while the other side is attached to the rest of the substrate by a part that is not “released”to be free-floating.

In FIG. 10C, the far end piece is clamped to the substrate, and is otherwise released from the substrate to be able to stretch and compress via the motions of the piezoelectric cantilever and ZPL cantilever/tuner. Cantilever 1012 comprises a piezoelectric layer (aluminum nitride) and electrodes (aluminum). Cantilever 1012 can push or pull against cavity 1000 depending on the polarity of the voltage applied to the electrodes. Voltages applied above and/or below the piezoelectric material can cause the cantilever to bend upward or downward. However, because of how the cantilever is attached to the cavity, this may also cause a push/pull of stretch or compression of the cavity structure. The cavity structure also may be bent up or down out its initial plane somewhat. The generated strain may be highly concentrated in the cavity region due to the large difference between the effective mechanical compliance of the cantilever piston and the cavity mirror regions. An additional “ZPL” (zero phonon line) piezoelectric cantilever 1014 is disposed underneath the center of cavity 1000. Applying +/−100 V to cantilever 1014 generates additional strain locally and independently of the cantilever 1012, allowing further adjustment of the cavity mode and the color center's ZPL emission frequency to better align with the optical resonance.

In some embodiments, the term “cantilever” may be used to refer to a larger piston in the device of FIG. 10C. In some embodiments, the term “tuner” may be used to refer to a smaller piston in the device of FIG. 10C. In some embodiments, the terms “cantilever” and “tuner” may be used interchangeably. In some embodiments, the piezoelectric cantilever 1014 may not act in the device of FIG. 10C as a cantilever per se, as described elsewhere herein. Piezoelectric cantilever 1014 may be attached to the silicon substrate or mostly released from the substrate to be free floating (e.g., except for a necessary connection of the Al metals to underlying routing metal with a tungsten via) with the rest of the structure. In some embodiments, what causes the ZPL tuning is applying a voltage across the piezo stack, which induces strain in the diamond waveguide at the top of the structure. The strain may induce a shift in the ZPL frequency. In some embodiments, piezoelectric cantilever 1014 and other similar components may be referred to as a piezoelectric component.

Similar to FIG. 10C, FIG. 10D depicts a schematic 1040 of the integrated cavity strain tuning platform. The hybrid cavity may be mechanically coupled to one or more of two piezoelectric tuners: a zero-phonon line (ZPL) tuner and a cantilever tuner (e.g., a piston tuner). The ZPL tuner may be actuated by an applied voltage V_{ZPL}, while the cantilever tuner may be actuated by voltage Vₚ and have a length Lₚ extending from the anchored region to the free end of the cantilever. Schematic 1040 shows oxide cladding positioned above the silicon nitride grating, aluminum electrodes layered on either side of the piezoelectric material, an aluminum nitride piezoelectric section located adjacent to the distal region of the cavity, the patterned silicon nitride grating with tapered periodicity arranged across the substrate surface, and a diamond nanobeam waveguide spanning perpendicular to the grating lines. The diamond nanobeam waveguide corresponds to photon collection efficiency η₂ and may be coupled to a photonic integrated circuit. The arrangement of schematic 1040 may enable independent electrical control of cavity resonance and emitter ZPL wavelength.

FIG. 10E depicts a view 1050 of simulated strain profiles εₓₓ generated when the ZPL tuner is driven with a V_{ZPL} of ±100 V. The results show strain propagating vertically through the silicon nitride grating stack into the diamond nanobeam, thereby shifting the ZPL wavelength of an emitter located within the waveguide. This configuration may allow fine tuning of individual color centers embedded in the hybrid cavity.

FIG. 10F depicts a view 1060 of total x-direction displacements (dₓ, in nm) of the hybrid cavity structure when Vₚ voltages of ±50 V are applied to the cantilever tuner. The displacement profiles of view 1060 indicate that the cantilever tuner can apply significant strain and resulting geometric deformation to the central cavity region, thereby enabling broadband tuning of the cavity resonance frequency.

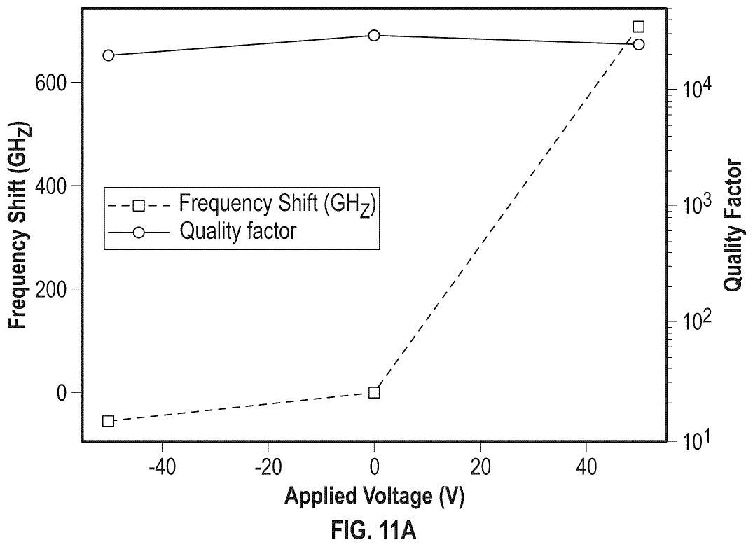

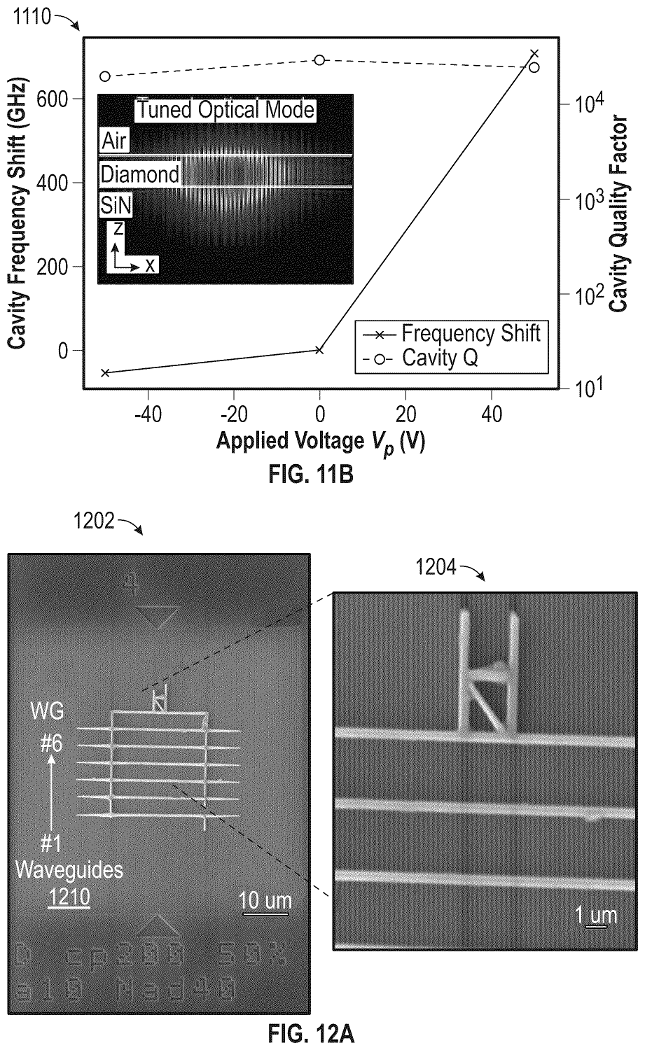

FIG. 11A shows example data relating the voltage applied to a piezoelectric cantilever in a piezoelectrically actuated hybrid photonic crystal cavity (e.g., cavity 1000 shown in FIGS. 10A-10C) to the quality factor of the crystal cavity. The cavity mode is tuned up to 760 GHz by applying voltage between −50 V and 50 V to the piezoelectric cantilever. The quality factor of the PhC cavity is preserved during the tuning.

Similar to FIG. 11A, FIG. 11B depicts a plot 1110 of simulated tuning of the cavity optical mode under application of Vₚ voltages from −50 V to +50 V. Plot 1110 demonstrates a cavity resonance frequency shift of approximately 760 GHz relative to the unperturbed cavity, while maintaining a high quality factor. The inset of plot 1110 depicts the cavity electric-field magnitude for Vₚ=0 in an XZ cross-section of the structure.

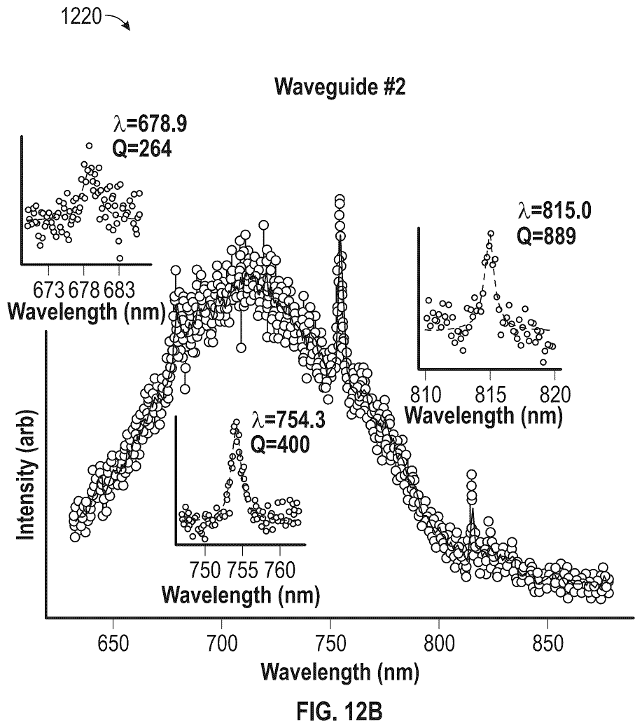

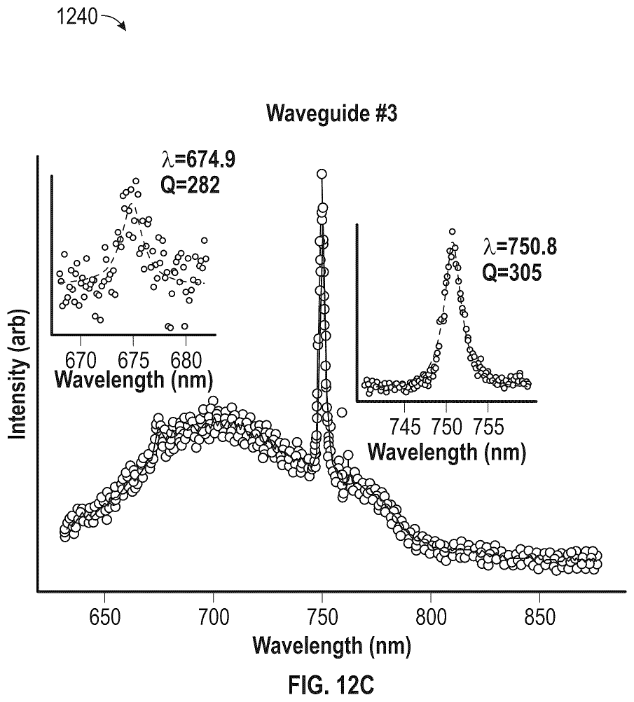

FIG. 12A depicts views 1202 and 1204 of scanning electron microscope (SEM) images of a diamond chiplet including an array of nanobeams (e.g., waveguides 1210 including waveguides #1 through #6) supported by a transfer frame. Each nanobeam may span parallel silicon nitride grating lines fabricated on a silicon oxide substrate, with its longitudinal axis oriented perpendicular to the grating. The chiplet architecture may enable multiple hybrid cavities to be fabricated and interrogated in parallel. The frame structure may facilitate transfer of the nanobeams from the bulk diamond substrate to the CMOS-compatible platform. Magnified view 1204 depicts three nanobeams bridging the grating region, forming hybrid cavities in which the optical mode is confined jointly within the diamond nanobeam and the silicon nitride grating. The diamond material may host negatively charged nitrogen vacancy (NV⁻) centers, which may emit broadband photoluminescence extending from approximately 637 nm to 850 nm at room temperature when optically excited by a 532 nm laser. This broadband emission may interact with the cavity and may be enhanced at discrete wavelengths corresponding to the cavity modes of the hybrid structure.

FIG. 12B depicts a measured emission spectrum 1220 (intensity as a function of wavelength) from waveguide #2 of the chiplet depicted in FIG. 12A. Narrow resonant peaks are observed on top of the NV emission band, corresponding to hybrid cavity modes. Resonances occur at wavelengths of 678.9 nm (Q of 264), 754.3 nm (Q of 400), and 815.0 nm (Q of 889), as determined by Lorentzian fits to the spectral peaks (e.g., shown in inset views). The presence of multiple resonances demonstrates coupling of NV emission to hybridized optical modes supported by the diamond nanobeam-silicon nitride grating structure. The measured Q factors demonstrate confinement of light despite fabrication imperfections, and the selective enhancement of emission at resonance demonstrates Purcell enhancement of NV emission into cavity modes. Even at Q values in the several hundreds, Purcell factors may exceed 10 and versions of the same hybrid cavity design may reach Q values above 10⁵ with simulated mode volumes of approximately 1.2 (λ/neff)³.

FIG. 12C depicts a measured emission spectrum 1240 (intensity as a function of wavelength) from waveguide #3 of the chiplet depicted in FIG. 12A. Resonances are observed at 674.9 nm (Q of 282) and 750.8 nm (Q of 305). The different resonant wavelengths relative to waveguide #2 may be the result of dimensional variation between nanobeams of waveguide #2 and waveguide #3, such as width, thickness, and/or placement with respect to the silicon nitride grating. This variation demonstrates that adjacent nanobeams within a single chiplet can act as distinct hybrid cavities with shifted resonances, thereby enabling coarse tuning of cavity modes across an array. Such coarse tuning may be combined with piezoelectric tuning as described above to align the cavity resonance with the zero-phonon line of an emitter.

### Example—Hybrid PhC Cavities for Quantum Computing

A hybrid PhC cavity such as those described herein can be integrated onto a wafer-scale CMOS photonic integrated circuit (PIC) platform. The PhC cavity can be attached to a piezoelectric cantilever (e.g., cantilever 1012 shown in FIGS. 10A-10B) to allow for tuning of the cavity mode and wavelength and frequency of quantum emitters embedded in the nanobeam. The voltages used to tune the cavity mode and the quantum emitters can be less than 100 V. In some embodiments, the cavity mode and color center emission can be tuned independently. The cavity mode may tune at a rate an order of magnitude larger than the emitter. Spectrally aligning the cavity and emitter modes to each other and to additional emitter-hybrid cavity structures on the same PIC can facilitate improved efficiency of generation of identical emitters for high-fidelity quantum information processing.

### EXEMPLARY EMBODIMENTS

The following are exemplary enumerated embodiments:
Embodiment 1. An apparatus comprising at least one photonic crystal cavity, the at least one photonic crystal cavity comprising:
   a grating comprising a first dielectric material;
   a nanobeam comprising a second dielectric material deposited on a surface of the grating, wherein a longitudinal axis of the nanobeam is oriented at a non-parallel angle to the grating.
Embodiment 2. The apparatus of embodiment 1, wherein a pitch of the grating varies along a direction parallel to the longitudinal axis of the nanobeam.
Embodiment 3. The apparatus of embodiment 2, wherein the pitch of the grating increases from a medial region of the grating to distal regions of the grating.
Embodiment 4. The apparatus of embodiment 2, wherein the pitch of the grating decreases from a medial region of the grating to a distal regions of the grating.
Embodiment 5. The apparatus of embodiment 2, wherein the pitch of the grating varies adiabatically.
Embodiment 6. The apparatus of embodiment 5, wherein an adiabatic taper length of the grating is between 0 μm and 20 μm.
Embodiment 7. The apparatus of embodiment 1, wherein, between a midpoint of the grating and an edge of the grating, the grating comprises between 5 and 30 periods.
Embodiment 8. The apparatus of embodiment 1, wherein, between a midpoint of the grating and an edge of the grating, the grating comprises between 5 and 60 periods.
Embodiment 9. The apparatus of embodiment 1, wherein a thickness of the grating is between 100 and 200 nm.
Embodiment 10. The apparatus of embodiment 1, wherein a duty cycle of the grating is between 25% and 75%.
Embodiment 11. The apparatus of embodiment 10, wherein the duty cycle of the grating is about 50%.
Embodiment 12. The apparatus of embodiment 1, wherein a pitch of the grating along a direction parallel to the longitudinal axis of the nanobeam is constant.
Embodiment 13. The apparatus of embodiment 12, wherein the pitch of the grating is between 150 nm and 250 nm.
Embodiment 14. The apparatus of embodiment 1, wherein a width of the nanobeam varies along the longitudinal axis of the nanobeam.
Embodiment 15. The apparatus of embodiment 14, wherein the width of the nanobeam increases from a medial region of the nanobeam to distal regions of the nanobeam.
Embodiment 16. The apparatus of embodiment 14, wherein the width of the nanobeam decreases from a medial region of the nanobeam to distal regions of the nanobeam.
Embodiment 17. The apparatus of embodiment 14, wherein the width of the nanobeam at a midpoint of the longitudinal axis of the nanobeam is between 150 nm and 500 nm.
Embodiment 18. The apparatus of embodiment 14, wherein the width of the nanobeam at a midpoint of the longitudinal axis of the nanobeam is between 150 nm and 600 nm.
Embodiment 19. The apparatus of embodiment 1, wherein the width of the nanobeam tapers by between 0 μm and 400 nm between a midpoint of the longitudinal axis of the nanobeam and an interior edge of a distal region of the grating.
Embodiment 20. The apparatus of embodiment 1, wherein a thickness of the nanobeam is between 50 nm and 200 nm.
Embodiment 21. The apparatus of embodiment 1, wherein a thickness of the nanobeam is between 50 nm and 300 nm.
Embodiment 22. The apparatus of embodiment 1, wherein the nanobeam is a waveguide.
Embodiment 23. The apparatus of embodiment 22, wherein the nanobeam comprises one or more quantum emitters.
Embodiment 24. The apparatus of embodiment 23, wherein an emitter mode of the one or more quantum emitters is spectrally aligned with a cavity mode of the photonic crystal cavity.
Embodiment 25. The apparatus of embodiment 1, wherein the second dielectric material is diamond.
Embodiment 26. The apparatus of embodiment 1, wherein the first dielectric material is silicon nitride (SiN).
Embodiment 27. The apparatus of embodiment 1, wherein the grating is deposited on a surface of a substrate.
Embodiment 28. The apparatus of embodiment 27, wherein the substrate comprises silicon dioxide (SiO₂).
Embodiment 29. The apparatus of embodiment 1, wherein a mode volume of the photonic crystal cavity is less than 1.5 (λ/η_{eff})³, where η_{eff} is an effective refractive index of a cavity mode.
Embodiment 30. The apparatus of embodiment 1, wherein a quality factor of the photonic crystal cavity is greater than 10⁵.
Embodiment 31. The apparatus of embodiment 1, wherein the photonic crystal cavity was fabricated using a semiconductor manufacturing process.
Embodiment 32. The apparatus of embodiment 31, wherein the photonic crystal cavity was fabricated using CMOS fabrication techniques.
Embodiment 33. A photonic system comprising:
   a photonic crystal cavity comprising:
      a grating comprising a first dielectric material; and
   a nanobeam comprising a second dielectric material deposited on a surface of the grating, wherein a longitudinal axis of the nanobeam is oriented perpendicular to the grating; and
   an output waveguide, wherein a distal region of the output waveguide underlies and is optically coupled to receive light from a distal region of the nanobeam.
Embodiment 34. A photonic system comprising:
   a photonic crystal cavity comprising:
      a grating comprising a first dielectric material; and
   a nanobeam comprising a second dielectric material deposited on a surface of the grating, wherein a longitudinal axis of the nanobeam is oriented perpendicular to the grating;
   wherein a pitch of adjacent dielectric beams the grating within an adiabatic taper region varies adiabatically and widths of individual dielectric beams of the grating are alternated in the adiabatic taper region of the grating, wherein the adiabatic pitch variation and beam width alternation cause light from the cavity to be emitted upward from the cavity.
Embodiment 35. The Photonic System of Embodiment 34, Further comprising:
   a substrate, wherein the grating is deposited on a surface of the substrate; and
   a metal backplane for the substrate, wherein the backplane is configured to redirect light emitted by the nanobeam into the substrate away from the substrate.
Embodiment 36. A photonic system comprising:
   a photonic crystal cavity comprising:
      a grating comprising a first dielectric material; and
   a nanobeam comprising a second dielectric material deposited on a surface of the grating,
wherein a longitudinal axis of the nanobeam is oriented perpendicular to the grating,
wherein a first distal region of the photonic crystal cavity is affixed to a substrate;
a piezoelectric component comprising a free-floating distal region connected to a second distal region of the photonic crystal cavity; and
a voltage source configured to apply a voltage to the piezoelectric component, wherein applying the voltage to the piezoelectric component generates strain in the photonic crystal cavity.
   Embodiment 37. The photonic system of embodiment 36, wherein the piezoelectric component comprises:
      a piezoelectric layer comprising a piezoelectric material; and
      a pair of electrode layers sandwiching the piezoelectric layer.
   Embodiment 38. The photonic system of embodiment 37, wherein the piezoelectric material comprises aluminum nitride.
   Embodiment 39. The photonic system of embodiment 37, wherein the electrode layers comprise aluminum.
   Embodiment 40. The photonic system of embodiment 36, further comprising:
      a second piezoelectric component cantilever disposed beneath and connected to a medial region of the photonic crystal cavity, wherein the voltage source is configured to apply a second voltage to the second piezoelectric component, wherein applying the second voltage to the piezoelectric component generates strain in the photonic crystal cavity.
   Embodiment 41. A method comprising:
      confining light to at least one region of a photonic crystal cavity comprising:
         a grating comprising a first dielectric material; and
         a nanobeam comprising a second dielectric material deposited on a surface of the grating, wherein a longitudinal axis of the nanobeam is oriented perpendicular to the grating.
   Embodiment 42. The method of embodiment 41, wherein the at least one region comprises the nanobeam and the grating.
   Embodiment 43. The method of embodiment 41, wherein the at least one region comprises the nanobeam and an air gap between beams of the grating.
   Embodiment 44. The method of embodiment 41, further comprising: transmitting light from a distal end of the nanobeam to an output waveguide that is optically coupled to receive light from the nanobeam.
   Embodiment 45. The method of embodiment 41, further comprising:
      determining a cavity mode associated with the photonic crystal cavity; and
      tuning the cavity mode using a piezoelectric component connected to the photonic crystal cavity.
   Embodiment 46. The method of embodiment 45, wherein tuning the cavity using the piezoelectric component comprises applying a voltage to the piezoelectric component based on the determined cavity mode.
   Embodiment 47. The method of embodiment 45, wherein tuning the cavity using the piezoelectric component comprises tuning a zero-phonon line frequency of the emitter independently of the cavity mode.
   Embodiment 48. The method of embodiment 41, further comprising spectrally aligning an emitter mode and a cavity mode associated with the photonic crystal cavity.
   Embodiment 49. A Photonic System Comprising:
      a photonic crystal cavity comprising:
         a grating comprising a first dielectric material; and
         a nanobeam comprising a second dielectric material deposited on a surface of the grating,
         wherein a longitudinal axis of the nanobeam is oriented perpendicular to the grating, wherein a first distal region of the photonic crystal cavity is affixed to a substrate;
      a piezoelectric component comprising a free-floating distal region connected to a second distal region of the photonic crystal cavity; and
      a voltage source configured to apply a voltage to the piezoelectric component, wherein applying the voltage to the piezoelectric component generates strain and resulting geometric deformation in the photonic crystal cavity.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

Finally, the entire disclosure of the patents and publications referred to in this application are hereby incorporated herein by reference.

1. A photonic system comprising:
a photonic crystal cavity comprising:
a grating comprising a first dielectric material; and
a nanobeam comprising a second dielectric material deposited on a surface of the grating,
wherein a longitudinal axis of the nanobeam is oriented perpendicular to the grating, wherein a first distal region of the photonic crystal cavity is affixed to a substrate;
a piezoelectric component comprising a free-floating distal region connected to a second distal region of the photonic crystal cavity; and
a voltage source configured to apply a voltage to the piezoelectric component, wherein applying the voltage to the piezoelectric component generates strain in the photonic crystal cavity.

2. The photonic system of claim 1, wherein the piezoelectric component comprises:
a piezoelectric layer comprising a piezoelectric material; and
a pair of electrode layers sandwiching the piezoelectric layer.

3. The photonic system of claim 2, wherein the piezoelectric material comprises aluminum nitride.

4. The photonic system of claim 2, wherein the electrode layers comprise aluminum.

5. The photonic system of claim 1, further comprising:
a second piezoelectric component cantilever disposed beneath and connected to a medial region of the photonic crystal cavity,
wherein the voltage source is configured to apply a second voltage to the second piezoelectric component, wherein applying the second voltage to the piezoelectric component generates strain in the photonic crystal cavity.

6. The photonic system of claim 1, wherein a pitch of the grating varies along a direction parallel to the longitudinal axis of the nanobeam.

7. The photonic system of claim 6, wherein the pitch of the grating increases from a medial region of the grating to distal regions of the grating.

8. The photonic system of claim 6, wherein the pitch of the grating decreases from a medial region of the grating to distal regions of the grating.

9. The photonic system of claim 6, wherein the variation in the pitch of the grating supports adiabatic mode conversion.

10. The photonic system of claim 9, wherein an adiabatic taper length of the grating is between 0 μm and 10 μm.

11. The photonic system of claim 1, wherein a thickness of the grating is between 100 nm and 300 nm.

12. The photonic system of claim 1, wherein a duty cycle of the grating is between 25% and 75%.

13. The photonic system of claim 1, wherein a width of the nanobeam varies along the longitudinal axis of the nanobeam.

14. The photonic system of claim 13, wherein the width of the nanobeam increases from a medial region of the nanobeam to distal regions of the nanobeam.

15. The photonic system of claim 13, wherein the width of the nanobeam decreases from a medial region of the nanobeam to distal regions of the nanobeam.

16. The photonic system of claim 1, wherein the nanobeam at a midpoint of the longitudinal axis of the nanobeam is between 150 nm and 600 nm.

17. The photonic system of claim 1, wherein a thickness of the nanobeam is between 50 nm and 300 nm.

18. The photonic system of claim 1, wherein the nanobeam comprises one or more quantum emitters.

19. The photonic system of claim 18, wherein an emitter mode of the one or more quantum emitters is spectrally aligned with a cavity mode associated with the photonic crystal cavity.

20. The photonic system of claim 1, wherein the second dielectric material is diamond.

21. The photonic system of claim 1, wherein the first dielectric material is silicon nitride.

22. The photonic system of claim 1, wherein the photonic crystal cavity is configured for in-plane coupling and a distal end of the nanobeam is optically coupled to an output waveguide.

23. The photonic system of claim 1, wherein the photonic crystal cavity is configured for out-of-plane coupling by alternating widths of the grating beams in an adiabatic taper region.

24. The photonic system of claim 23, further comprising a backplane disposed beneath the grating to redirect light upward from the cavity.

25. The photonic system of claim 1, wherein a mode volume of the photonic crystal cavity is less than 1.5 (λ/n_{eff})³, wherein n_{eff} comprises an effective refractive index of a cavity mode associated with the photonic crystal cavity.

26. The photonic system of claim 1, wherein a quality factor of the photonic crystal cavity is greater than 10⁵.
